(19) United States
(12) Patent Application Publication
(10) Pub. No.: US 2015/0055701 A1
(43) Pub. Date: Feb. 26, 2015

(54) IMAGE ENCODING/DECODING APPARATUS AND METHOD

(71) Applicant: HUMAX HOLDINGS CO., LTD., Yongin-Si (KR)

(72) Inventors: Alex Chungku YIE, Incheon (KR); Joon Seong Park, Yongin-si (KR)

(21) Appl. No.: 14/528,536

(22) Filed: Oct. 30, 2014

Related U.S. Application Data
(63) Continuation of application No. 13/576,607, filed on Aug. 1, 2012.

(30) Foreign Application Priority Data
Feb. 2, 2010 (KR) 10-2010-0009358
Jun. 11, 2010 (KR) 10-2010-0055209
Jul. 26, 2010 (KR) 10-2010-0071848

(51) Int. Cl. H04N 19/105; H04N 19/176; H04N 19/137

(52) U.S. Cl. CPC H04N 19/105; H04N 19/137; H04N 19/176
USPC 375/240.03

(57) ABSTRACT

Motion vector for input coding unit is generated, motion compensation is performed on the basis of generated motion vector to generate prediction signal, weight parameter is generated on prediction unit basis, weight parameter is applied to the prediction signal to generate prediction macro block, and residue value is generated on the basis of received coding unit and the prediction block. The same motion parameter is allocated to the merged blocks, and the blocks are transmitted to decoder. Image encoding/decoding method selects interpolating filters to be used in inter-frame prediction based on motion compensation, for units more precise than picture unit, wherein said more precise units include at least one of slice unit and partition unit, and calculates sub-pixel values. According to present invention, quality of encoded image can be improved, and efficiency of encoding high resolution images having resolution higher than high definition (HD) class can be improved.

### CROSS-REFERENCE TO RELATED APPLICATION

The present application is a continuation of U.S. patent application Ser. No. 13/576,607, filed on Aug. 1, 2012. Further, this application claims the priorities of Korean Patent Application No. 10-2010-0071848, filed on Jul. 26, 2010; No. 10-2010-0055209, filed on Jun. 11, 2010; and No. 10-2010-0009358, filed on Feb. 2, 2010 in the KIPO (Korean Intellectual Property Office) and National Phase application of International Application No. PCT/KR2011/000786, filed on Feb. 7, 2011, the disclosure of which are incorporated herein in their entirety by reference.

### TECHNICAL FIELD

The present invention is directed to encoding/decoding of images, and more specifically to an image encoding/decoding apparatus and method that may apply to images having an HD (High Definition) or higher resolution.

### BACKGROUND ART

In a general image compressing method, encoding is performed with one picture separated into a plurality of blocks each having a predetermined size. Further, to raise compression efficiency, inter-frame prediction and intra-frame prediction technologies are used that eliminate redundancy between pictures.

An inter-frame prediction-based image encoding method compresses images by removing spatial redundancy between pictures, and a representative example thereof is a motion compensating prediction encoding method.

The motion compensating prediction encoding searches for a region similar to a block being currently encoded in at least one reference picture positioned before and/or behind a picture being currently encoded to thereby generate a motion vector and uses the generated motion vector to perform motion compensation, thereby obtaining a prediction block. Then, the residue of the current block and the prediction block undergoes DCT (Discrete Cosine Transform), quantization, and entropy encoding, and is then transmitted.

In general, a macroblock of various sizes, such as 16×16, 8×16, and 8×8 pixels, is used for motion compensating prediction, and a block whose size is 8×8 or 4×4 pixels is used for transform and quantization.

In the motion compensating prediction encoding method, if the prediction motion vector fails to exactly predict the motion of the current block to be encoded, the residue of the current block and the prediction block increases, thus resulting in a decrease in encoding efficiency. Accordingly, there is a need for a motion vector prediction method that may generate the motion vector more exactly and may reduce the residue of the current block and the prediction block.

Intra-frame prediction is a method of compressing images by removing spatial redundancy using pixel correlation between blocks in one picture, and this method generates a prediction value of a current block to be encoded from the current block and encoded pixels adjacent to the current block and then compresses the residue of the pixels of the current block and the generated prediction value.

Typically, the size of a block used for intra-frame prediction is 4×4, 8×8, or 16×16 pixels.

Further, H.264/AVC provides a weighted prediction method to make up for the shortcoming that when the above-described motion compensation is used to compress an image, the brightness of the image is not predicted so that when an image whose brightness changes over time, such as fade-in or fade-out, is encoded, the quality of the image is deteriorated.

The weighted prediction method may be largely divided into an explicit mode and an implicit mode. The implicit mode allows a decoder to calculate a weighted value by a temporal distance between a current picture and reference pictures without separately encoding a weighted value used for prediction of the current block, and the explicit mode operates the weighted prediction parameter on a per-slice basis and transmits it to the encoding unit.

### DISCLOSURE

### Technical Problem

However, since the above-described weighed prediction method is performed on a per-slice basis, it fails to perform a high accuracy of weighed prediction and has the shortcoming that multi-path encoding needs to be done.

Accordingly, there is a need for an encoding method that may apply to encoding of high-resolution images having an HD or higher resolution while increasing accuracy of weighed prediction.

On the other hand, motion compensating intra-frame prediction generates a motion vector (MV) with one picture separated into plural blocks each having a predetermined size and conducts motion compensation using the generated motion vector. The individual motion parameter for each of the prediction blocks obtained by performing motion compensation is transmitted to the decoder.

Since the motion vectors may have non-integer values, motion compensation intra-frame prediction requires evaluation of pixel values of the reference picture at the non-integer positions. In the non-integer positions, the pixel values are referred to as sub pixel values, and the procedure for determining these values is referred to as interpolation. Calculation of sub pixels are done by filtering that applies a filter coefficient to adjacent pixels of the integer pixel of the reference picture. For example, in H.264/AVC, P picture is predicted by using 6-tab interpolating filter having filter coefficients ((1, −5, 20, 20, −5, 1)/32). In general, the higher order of a filter is used, the better performance is achieved. However, the amount of transmission of the filter coefficient of the interpolating filter which is to be transmitted to the decoder will increase as much.

In case of a high-resolution image having a HD or higher resolution, the number of blocks per picture increases. Thus, as the motion parameter is transmitted to the decoder for each and every prediction block, the amount of the motion parameter to be transmitted increases and this is not preferable in terms of coding efficiency. Accordingly, a method for raising coding efficiency is required.

A first object of the invention is to provide a weighed prediction-based image encoding/decoding method that may enhance accuracy of weighed prediction and that may apply to high-resolution images.

A second object of the invention is to provide a weighed prediction-based image encoding/decoding apparatus that performs the image encoding/decoding method.

A third object of the invention is to provide an image encoding method and apparatus that uses block merging that may apply to high-resolution images having an HD or higher resolution.

A fourth object of the invention is to provide an image decoding method and apparatus that uses block merging that may apply to high-resolution images having an HD or higher resolution.

A fifth object of the invention is to provide an image encoding method and apparatus to enhance encoding accuracy of high-resolution images having an HD or higher resolution.

A sixth object of the invention is to provide an image decoding method and apparatus to enhance decoding accuracy of high-resolution images having an HD or higher resolution.

### Technical Solution

A method of encoding an image using weighed prediction according to an aspect of the present invention to achieve the first object of the present invention includes the steps of generating a motion vector for an input coding unit, performing motion compensation based on the generated motion vector to generate a prediction signal, generating a weighed parameter on a per-prediction unit basis, applying the weighed parameter to the prediction signal to generate a prediction block, and generating a residue based on the received coding unit and the prediction block. The coding unit may include an extended macroblock having a size of 32×32 pixels or more.

A method of decoding an image using weighted prediction according to an aspect of the present invention to achieve the first object of the present invention includes the steps of entropy-encoding a received bit stream to extract a quantized residue, a motion vector, and a weight parameter, inverse-quantizing and inverse-transforming the quantized residue to restore the residue, performing motion compensation using the motion vector to generate a prediction signal, applying the weight parameter to the prediction signal to generate a prediction block, and restoring a current block based on the residue and the prediction block. The prediction block may include an extended macroblock having a size of 32×32 pixels.

A method of encoding an image using block merging according to an aspect of the present invention to achieve the third object of the present invention includes the steps of Performing motion compensation inter-frame prediction on a prediction unit and performing block merging that merges samples belonging to a mergeable block set including adjacent samples of a current block with the current block after partitioning on the prediction unit is done, wherein the same motion parameter is allocated to the merged block and sent to a decoder. The mergeable block set may include at least one of a block generated by asymmetric partitioning and a block generated by geometrical partitioning.

A method of decoding an image using block merging according to an aspect of the present invention to achieve the fourth object of the present invention includes the steps of entropy-decoding a received bit stream and inverse-quantizing and inverse-transforming a residue to restore the residue, performing motion compensation using prediction unit information and a motion parameter to generate a prediction unit, adding the residue to the prediction unit to restore the image, wherein after partitioning on the prediction unit is done, among blocks belonging to a mergeable block set, a block merged with a current block has the same motion parameter. The mergeable block set may include at least one of a block generated by asymmetric partitioning and a block generated by geometrical partitioning. Header information decoded through the entropy decoding may include prediction unit information and a motion parameter for motion compensation and prediction. The motion parameter may include a motion parameter transmitted for each block merged by the block merging.

An image decoding apparatus using block merging according to another aspect of the present invention to achieve the fourth object of the present invention includes an inverse-quantizing and inverse-transformation unit that entropy-decodes a received bit stream and inverse-quantizes and inverse-transforms a residue to restore the residue, a motion compensation unit that performs motion compensation using prediction unit information and motion parameter to generate a prediction unit, and an adder that adds the residue to the prediction unit to restore an image, wherein after partitioning on the prediction unit is done, among blocks belonging to a mergeable block set, a block merged with a current block has the same motion parameter. The mergeable block set may include at least one of a block generated by asymmetric partitioning and a block generated by geometrical partitioning.

A method of encoding an image according to an aspect of the present invention to achieve the fifth object of the present invention includes the steps of generating a prediction unit for inter-frame prediction for an input image and performing motion compensation inter-frame prediction on the prediction unit, wherein the step of performing the motion compensation inter-frame prediction on the prediction unit includes calculating a sub-pixel value by selecting a filter used for the motion compensation inter-frame prediction on a basis more precise than a picture basis, wherein the more precise basis includes at least one of a slice basis, a prediction unit basis, and a partition basis. The step of performing the motion compensation inter-frame prediction on the prediction unit may include the steps of after performing partitioning on the prediction unit, performing block merging that merges a current block with samples belonging to a mergeable block set including adjacent samples of the current block and calculating a sub-pixel value by selecting filter information of a filter used for the motion compensation inter-frame prediction on the more precise basis, wherein the filter includes at least one of a filter index and a filter coefficient. The same filter information may be allocated to the merged block and sent to a decoder. The mergeable block set may include at least one of a block generated by asymmetric partitioning and a block generated by geometrical partitioning.

A method of decoding an image according to an aspect of the present invention to achieve the sixth object of the present invention includes the steps of entropy-decoding a received bit stream and inverse-quantizing and inverse-transforming a residue to restore the residue, generating a prediction unit using prediction unit information and a motion parameter, performing inter-frame prediction on the prediction unit using filter information encoded by selection on a basis more precise than a picture basis, wherein the more precise basis includes at least one of a slice basis, a prediction unit basis, and a partition basis, and wherein the filter information includes at least one of a filter index and a filter coefficient, and adding the residue to the prediction unit on which the inter-frame prediction has been performed to thereby restore an image. After partitioning on the prediction unit is done, among blocks belonging to a mergeable block set, a block merged with a current block may have the same filter information. The filter information may be filter information of a filter used for motion compensation inter-frame prediction. The mergeable block set may include at least one of a block generated by asymmetric partitioning and a block generated by geometrical partitioning. Header information decoded by the entropy decoding may include prediction unit information, and a motion parameter and filter information for motion compensation and prediction.

An image decoding apparatus according to another aspect of the present invention to achieve the sixth object of the present invention includes an inverse quantizing and inverse transform unit that entropy-encodes a received bit stream and inverse-quantizes and inverse-transforms a residue to restore the residue, a motion compensation unit that generates a prediction unit using prediction unit information and a motion parameter, and an adder that adds the residue to the a prediction unit to restore an image, wherein the motion compensation unit performs inter-frame prediction on the prediction unit using filter information encoded by selection on a basis more precise than a picture basis, wherein the more precise basis includes at least one of a slice basis, a prediction unit basis, and a partition basis, and wherein the filter information includes at least one of a filter index and a filter coefficient. After partitioning on the prediction unit is done, among blocks belonging to a mergeable block set, a block merged with a current block may have the same filter information. The filter information may be filter information of a filter used for motion compensation inter-frame prediction. The mergeable block set may include at least one of a block generated by asymmetric partitioning and a block generated by geometrical partitioning. Header information decoded by the entropy decoding may include prediction unit information, and a motion parameter and filter information for motion compensation and prediction.

### Advantageous Effects

According to the image encoding/decoding apparatus and method using weighed prediction as described above, an image is encoded with weighted prediction performed on a per extended macroblock basis, which may provide increased quality of encoded images compared with the existing weighted prediction encoding method that is carried out on a per-slice basis. Weighted prediction encoding is also performed on the basis of an extended macroblock having a size of 32×32, 64×64 pixels or more, thus resulting in an increase in encoding efficiency of high-resolution images having a HD or higher resolution.

Further, in the case that a partition unit is used as a unit of transmission of filter information-filter index or filter coefficient-of the interpolating filter used for motion compensation inter-frame prediction, the whole of the block merged by block merging is used as the transmission unit of the filter information, which reduces the amount of side information to be transmitted to the decoder, thus resulting in an increase in encoding efficiency of high-resolution images having an HD or higher resolution.

Further, the motion parameter is not transmitted for each and every prediction but transmitted once for the whole block merged by block merging, thus resulting in a decrease in the amount of transmission of side information such as motion parameter. Thus, it may be possible to increase encoding efficiency of high-resolution images having an HD or higher resolution.

Still further, the interpolating filter used for motion compensating inter-frame prediction of high-resolution images having an HD or higher resolution may be selected for more accurate basis than the picture basis—for example, slice basis or prediction unit basis, or partition basis (the partition basis may include the extended macroblock, macroblock or block)—thereby, resulting in an increase in encoding accuracy.

Yet still further, block merging is expanded to asymmetric partitioning and/or geometrical partitioning to thereby reduce the amount of transmission of side information such as motion parameter, thus resulting in an increase in encoding efficiency of high-resolution images having an HD or higher resolution.

### DESCRIPTION OF DRAWINGS

FIG. 1 is a conceptual view illustrating a recursive coding unit structure according to an embodiment of the present invention.

FIG. 2 is a block diagram illustrating a configuration of a weighted prediction-based image encoding apparatus according to an embodiment of the present invention.

FIG. 3 is a flowchart illustrating a weighted prediction-based image encoding method according to an embodiment of the present invention.

FIG. 4 is a block diagram illustrating a configuration of a weighted prediction-based image decoding apparatus according to an embodiment of the present invention.

FIG. 5 is a flowchart illustrating a weighted prediction-based image decoding method according to an embodiment of the present invention.

FIG. 6 is a conceptual view illustrating a process of selecting and using a filter on a per-slice basis according to an embodiment of the present invention.

FIG. 7 is a conceptual view illustrating a process of selecting and using a filter on a per-partition basis according to another embodiment of the present invention.

FIG. 8 is a conceptual view illustrating a process of selecting and using a filter on a per-asymmetric partitioning basis according to still another embodiment of the present invention.

FIG. 9 illustrates an example where geometric partitioning of a shape other than a square is performed on a prediction unit.

FIG. 10 is a conceptual view for describing a process of selecting and using a filter on the basis of a geometric partition of a shape other than a square according to still another embodiment of the present invention.

FIG. 11 is a conceptual view for describing a process of selecting and using a filter on the basis of a geometric partition of a shape other than a square according to still another embodiment of the present invention.

FIG. 12 is a conceptual view for describing an encoding method using block merging according to an embodiment of the present invention.

FIGS. 13 to 15 are conceptual views for describing an encoding method using block merging in case of asymmetrical partitioning according to still another embodiment of the present invention.

FIGS. 16 and 17 are conceptual views for describing an encoding method using block merging in case of geometrical partitioning according to still another embodiment of the present invention.

FIGS. 18 and 19 are conceptual views for describing an encoding method using block merging in case of geometrical partitioning according to yet still another embodiment of the present invention.

FIG. 20 is a flowchart illustrating an image encoding method using block merging according to an embodiment of the present invention.

FIG. 21 is a flowchart illustrating an image decoding method according to an embodiment of the present invention.

FIG. 22 is a conceptual view for describing a process of selecting and using a filter on a per-partition basis using block merging according to another embodiment of the present invention.

FIGS. 23 and 24 are conceptual views for describing a process of selecting and using a filter on a per-partition basis using block merging in case of asymmetrical partitioning according to another embodiment of the present invention.

FIG. 25 is a conceptual view for describing a process of selecting and using a filter on a per-partition basis using block merging in case of geometrical partitioning according to still another embodiment of the present invention.

FIGS. 26 and 27 are conceptual views for describing a process of selecting and using a filter on a per-partition basis using block merging in case of geometrical partitioning according to still another embodiment of the present invention.

FIG. 28 is a flowchart illustrating an image encoding method for selecting a filter on a per-slice or per-partition basis and performing encoding according to an embodiment of the present invention.

FIG. 29 is a block diagram illustrating a configuration of an image encoding apparatus for selecting a filter on a per-slice or per-partition basis and performing encoding according to an embodiment of the present invention.

FIG. 30 is a flowchart illustrating an image decoding method according to an embodiment of the present invention.

FIG. 31 is a block diagram illustrating a configuration of an image decoding apparatus according to an embodiment of the present invention.

### BEST MODEL

Various modifications and variations may be made to the present invention. Hereinafter, some particular embodiments will be described in detail with reference to the accompanying drawings.

However, it should be understood that the present invention is not limited to the embodiments and all the variations or replacements of the invention or their equivalents are included in the technical spirit and scope of the present invention.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the accompanying drawings, wherein the same reference numerals may be used to denote the same or substantially the same elements throughout the specification and the drawings, and description on the same elements will be not repeated.

In an embodiment of the present invention, an extended macroblock having a size of 32×32 pixels or more may be used to perform encoding and decoding, such as inter/intra-frame prediction, transform, quantization, or entropy encoding so as to apply to high-resolution images having an HD or higher resolution, or recursive coding unit (CU) structure may be used to perform encoding and decoding.

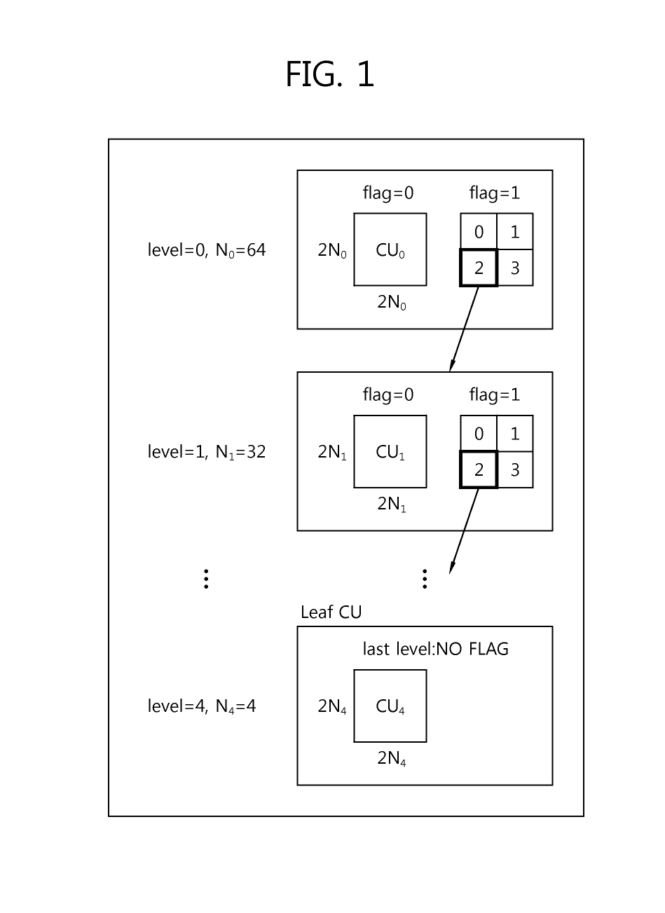

FIG. 1 is a conceptual view illustrating a recursive coding unit structure according to an embodiment of the present invention.

Referring to FIG. 1, each coding unit CU is shaped as a square, and each coding unit CU may have a variable size of 2N×2N (unit: pixels). Inter-frame prediction, intra-frame prediction, transform, quantization, and entropy encoding may be performed on a per-coding unit (CU) basis. The coding unit (CU) may include the largest coding unit (LCU) and the smallest coding unit (SCU), and the size of the largest coding unit (LCU) and the smallest coding unit (SCU) may be represented as powers of 2 which are 8 or more.

The coding unit (CU) according to an embodiment of the present invention may have a recursive tree structure. FIG. 1 illustrates an example where the size 2N0 of a side of the largest coding unit (LCU), CU0, is 128 (N0=64), and the largest hierarchical level or hierarchical depth is 5. The recursive structure may be represented through a series of flags. For example, in the case that the coding unit CUk whose hierarchical level or hierarchical depth is k has a flag value of 0, coding on the coding unit CUk is performed on the current hierarchical level or hierarchical depth, and in the case that the flag value is 1, the coding unit CUk whose current hierarchical level or hierarchical depth is k is split into four independent coding units CUk+1, the hierarchical level or hierarchical depth of the split coding units CUk+1 becomes k+1, and the size thereof becomes Nk+1×Nk+1. In such case, the coding unit CUk+1 may be represented as the sub coding unit of the coding unit CUk. The coding unit CUk+1 may be recursively processed until the hierarchical level or hierarchical depth of the coding unit CUk+1 reaches the maximally allowable hierarchical level or hierarchical depth. In the case that the hierarchical level or hierarchical depth of the coding unit CUk+1 is the same as the maximally allowable hierarchical level or hierarchical depth—for example, ‘5’ in FIG. 1, no more splitting is allowed.

The size of the largest coding unit (LCU) and the size of the smallest coding unit (SCU) may be included in a sequence parameter set (SPS). The sequence parameter set (SPS) may include the maximally allowable hierarchical level or hierarchical depth of the largest coding unit (LCU). For example, in the case shown in FIG. 1, the maximally allowable hierarchical level or hierarchical depth is 5, and in the case that the size of a side of the largest coding unit (LCU) is 128 (unit: pixels), five types of coding unit sizes, such as 128×128 (LCU), 64×64, 32×32, 16×16, and 8×8 (SCU), are available. That is, if the size and maximally allowable hierarchical level or hierarchical depth of the largest coding unit (LCU) are given, the allowable size of the coding unit may be determined.

The use of the above-described recursive coding unit structure according to an embodiment of the present invention provides the following advantages.

First, a larger size than the size of the existing 16×16 macroblock may be supported. If an image region of interest is homogeneous, the largest coding unit (LCU) may display the image region of interest with a smaller number of symbols than when a number of smaller blocks are used.

Second, compared with when a fixed size of macroblocks is used, the largest coding unit (LCU) having various sizes may be supported, so that a codec may be easily optimized for various contents, applications, and devices. That is, the size and the largest hierarchical level or largest hierarchical depth of the largest coding unit (LCU) may be properly selected, so that the hierarchical block structure may be further optimized for a target application.

Third, without discerning the macroblock, sub-macroblock, and extended macroblock, one single unit form, coding unit LCT, is used to be able to very simply represent the multi-level hierarchical structure by using the largest coding unit (LCT) size, the largest hierarchical level (or largest hierarchical depth) and a series of flags. When the size-independent syntax representation is used together, it is enough to specify a syntax item having a generalized size for the remaining coding tools, and this consistency helps simplify the actual parsing process. The maximum value of the hierarchical level (or the largest hierarchical depth) may be an arbitrary value, and may be larger than a value allowed by the existing H.264/AVC encoding scheme. All the syntax elements may be specified by a consistent method independent from the size of the coding unit CU by using the size-independent syntax representation. The splitting process on the coding unit CU may be recursively specified, and other syntax elements on the leaf coding unit—last coding unit of the hierarchical level—may be defined to have the same size irrespective of the coding unit size. The above-described method is very effective in reducing parsing complexity and may increase representation clarity when a large hierarchical level or hierarchical depth.

If the above-mentioned hierarchical splitting process is done, inter or intra-frame prediction may be performed on the leaf node in the coding unit hierarchical tree without further splitting, and this leaf coding unit is used as a prediction unit (PU) which is a basic unit for inter or intra-frame prediction.

That is, partitioning is performed on the leaf coding unit so as to do intra or inter-frame prediction. Partitioning is conducted on the prediction unit (PU). Here, the prediction unit (PU) means a basic unit for inter or intra-frame prediction, and as the prediction unit (PU), the existing macroblock unit or sub-macroblock unit, or an extended macroblock unit having a size of 32×32 pixels or more may be used.

Hereinafter, in an embodiment of the present invention, the extended macroblock means a block whose size is 32×32 pixels or 64×64 pixels or more.

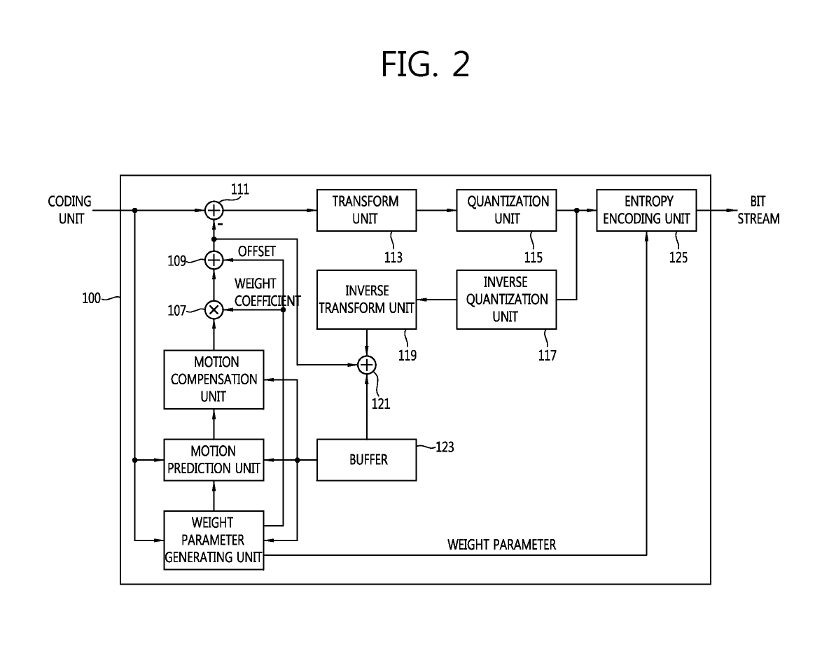

FIG. 2 is a block diagram illustrating a configuration of an image encoding apparatus using weighted prediction according to an embodiment of the present invention.

Referring to FIG. 2, the image encoding apparatus 100 according to an embodiment of the present invention may include a motion prediction unit 101, a motion compensation unit 103, a weight parameter generating unit 105, a first multiplier 107, a first adder 109, a second adder 111, a transform unit 113, a quantization unit 115, an inverse quantization unit 117, an inverse transform unit 119, a third adder 121, a buffer 123, and an entropy encoding unit 125.

The motion prediction unit 101 performs inter-frame prediction based on an input current coding unit and plural reference pictures that have been restored and stored in the buffer 123, thereby generating a motion vector. Here, the input coding unit may have a size of 16×16 pixels or less or may be an extended macroblock having a size of 32×32 pixels or more. Further, when plural reference pictures are used for motion prediction, as many motion vectors as corresponding thereto may be generated, and the generated motion vectors are provided to the motion compensation unit 103 and the entropy encoding unit 125.

The motion compensation unit 103 applies at least one motion vector provided from the motion prediction unit 101 to a reference prediction unit of a corresponding reference picture stored in the buffer 123 to thereby generate a motion-compensated prediction signal. For instance, in the case that two reference pictures are used to perform bi-prediction, two prediction signals Y0 and Y1 may be generated.

The weight parameter generating unit 105 generates a weight parameter by referring to a corresponding reference prediction unit of the reference picture stored in the third adder 121 with respect to the input coding unit. Here, the weight parameter may include a weight coefficient W and an offset D, and this may be determined based on a change in a brightness component of the reference prediction unit and the input coding unit. The weight coefficient W generated by the weight parameter generating unit 105 is provided to the first multiplier 107, and the offset D is provided to the first adder 109.

The first multiplier 107 multiplies the motion-compensated prediction signal provided from the motion compensation unit 103 by the weight coefficient provided from the weight parameter generating unit 105, and provides the result to the first adder. For example, two motion compensation units 103 use two reference pictures to thereby generate two prediction signals Y0 and Y1 and the weight parameter generating unit 105 provides two weight coefficients W0 and W1 respectively corresponding to the reference pictures, the output of the first multiplier 107 becomes W0Y0+W1Y1.

The first adder 109 adds the output of the first multiplier 107 to the offset value provided from the weight parameter generating unit 105 to thereby generate a prediction block and provides the prediction block to the second adder 111. For example, when two reference pictures are used to perform weighted prediction as described above, the generated prediction macroblock is W0Y0+W1Y1+D.

The second adder 111 subtracts the input current coding unit signal and the prediction block provided from the first adder 109 to thereby produce a residue and provides the residue to the transform unit 113.

The transform unit 113 performs DCT (Discrete Cosine Transform) on the residue provided from the second adder 111, and the quantization unit 115 performs quantization on the DCTed data and provides the quantized data to the entropy encoding unit 125 and the inverse quantization unit 117. Here, the transform unit 113 may perform the transform so that it has a size of an extended macroblock, such as 32×32 or 64×64 pixels.

The inverse quantization unit 117 inverse-quantizes the quantized data, and the inverse transform unit 119 inverse-transforms the inverse-quantized data and provides the result to the buffer 123.

The third adder 121 adds the inverse-transformed data, i.e., the residue, provided from the inverse transform unit 119 and the prediction block provided from the first adder 109 and provides the result to the buffer 123.

The buffer 123 may store plural restored pictures which may be used as reference pictures for motion prediction and generation of weight parameters.

The entropy encoding unit 125 performs entropy encoding on header information, such as the quantized DCT coefficients, motion vector, and weight parameters to thereby generate a bit stream.

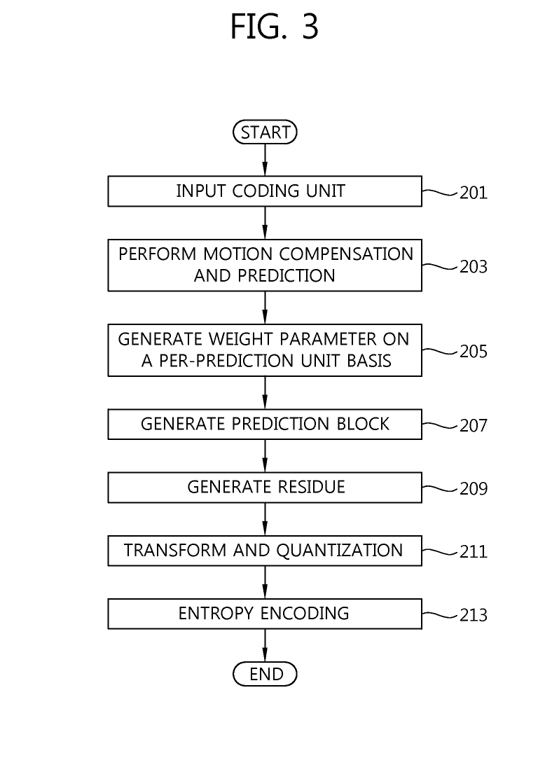

FIG. 3 is a flowchart illustrating an image encoding method using weighted prediction according to an embodiment of the present invention.

Referring to FIG. 3, when the coding unit is input to the encoding apparatus (step 201), inter-frame prediction is performed based on the input current coding unit and plural reference pictures that have been restored and stored in the buffer, thereby generating a motion vector, and the generated motion vector is used to perform motion compensation, thus generating a prediction signal (step 203). Here, the input coding unit may have a size of 16×16 pixels or less or may be an extended macroblock having a size of 32×32 pixels or more. Further, when the plurality of reference pictures are used for motion prediction, as many motion vectors as corresponding thereto may be generated.

Further, the encoding apparatus generates the weight parameter including the weight coefficient and the offset based on a change in the brightness component of the reference prediction unit (or reference macroblock) and the input coding unit (step 205).

Thereafter, the encoding apparatus generates a prediction block based on the prediction signal generated in step 203 and the weight parameter generated in step 205 (step 207). Here, the prediction block may be obtained by multiplying the prediction signal by the weight coefficient and adding the offset.

As described above, after the prediction block is generated, the encoding apparatus obtains a different between the input coding unit and the prediction block to thereby generate a residue (step 209).

Thereafter, the encoding apparatus quantizes the generated residue (step 211) and entropy-encodes the header information, such as the motion vector and weight parameter, and the quantized DCT coefficients, to thereby generate a bit stream (step 213).

In the image encoding apparatus and encoding method using weighted prediction according to an embodiment of the present invention as shown in FIGS. 2 and 3, weighted prediction is performed on a per-prediction unit basis (or on a per-macroblock basis) to thereby encode images, so that it may increase the quality of encoded images compared with the conventional weighted prediction encoding method that is performed on a per-slice basis. Further, when weighted prediction is conducted on the basis of an extended macroblock having a size of 32×32 or 64×64 pixels or more, encoding efficiency of high-resolution images may be increased.

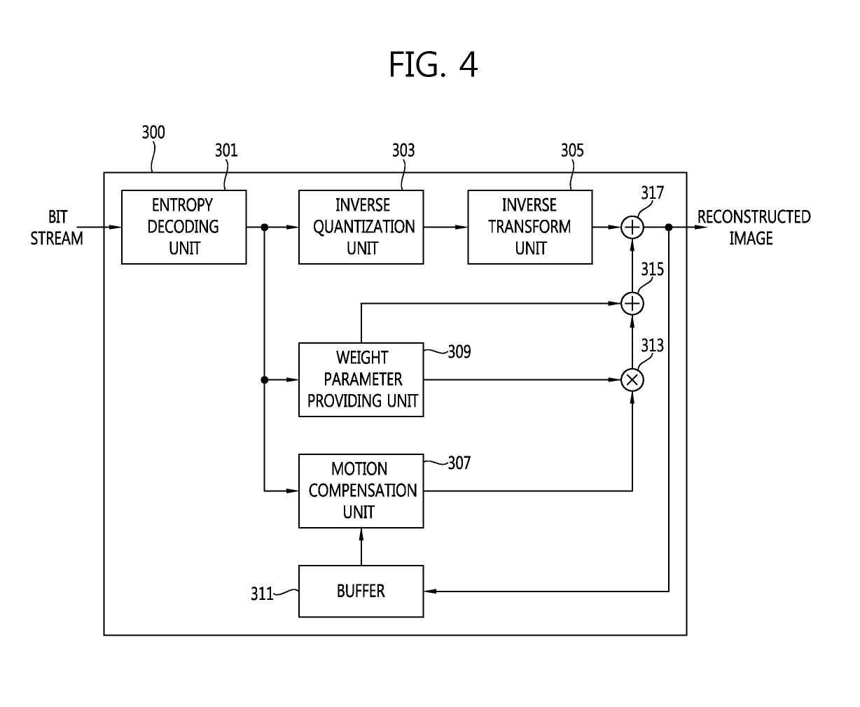

FIG. 4 is a block diagram illustrating a configuration of an image decoding apparatus using weighted prediction according to an embodiment of the present invention. FIG. 4 illustrates a configuration of a decoding apparatus that decodes the image encoded by the encoding apparatus shown in FIG. 2.

Referring to FIG. 4, the decoding apparatus 300 according to an embodiment of the present invention may include an entropy decoding unit 301, an inverse quantization unit 303, an inverse transform unit 305, a motion compensation unit 307, a weight parameter providing unit 309, a buffer 311, a second multiplier 313, a fourth adder 315, and a fifth adder 317.

The entropy decoding unit 301 entropy-decodes the bit stream provided from the encoding apparatus and provides the weight parameter and motion vector and residue of a macroblock to be currently decoded.

The inverse quantization unit 303 inverse-quantizes the residue provided from the entropy decoding unit 301, and the inverse transform unit 305 inverse-transforms the inverse-quantized data.

The motion compensation unit 307 applies the motion vector provided from the entropy decoding unit 301 to the reference prediction unit of the reference picture stored in the buffer 311, thereby generating a motion-compensated prediction signal, and provides the generated prediction signal to the motion compensation unit 307.

The weight parameter providing unit 309 receives the weight parameter from the entropy decoding unit 301 and provides the weight coefficient to the second multiplier 313 and the offset to the fourth adder 315.

The restored image provided from the fifth adder 317 is provided to the buffer 311. The restored image provided to the buffer 311 is used as a reference picture for performing motion prediction.

The second multiplier 313 multiplies the prediction signal provided from the motion compensation unit 307 by the weight coefficient provided from the weight parameter providing unit 309 and provides the result to the fourth adder 315, and the fourth adder 315 adds the signal provided from the second multiplier 313 and the offset provided from the weight parameter providing unit 309 to thereby generate a prediction block and provides the prediction block to the fifth adder 317.

The fifth adder 317 adds the residue provided from the inverse transform unit 305 and the prediction block provided from the fourth adder 315 to thereby restore the current block.

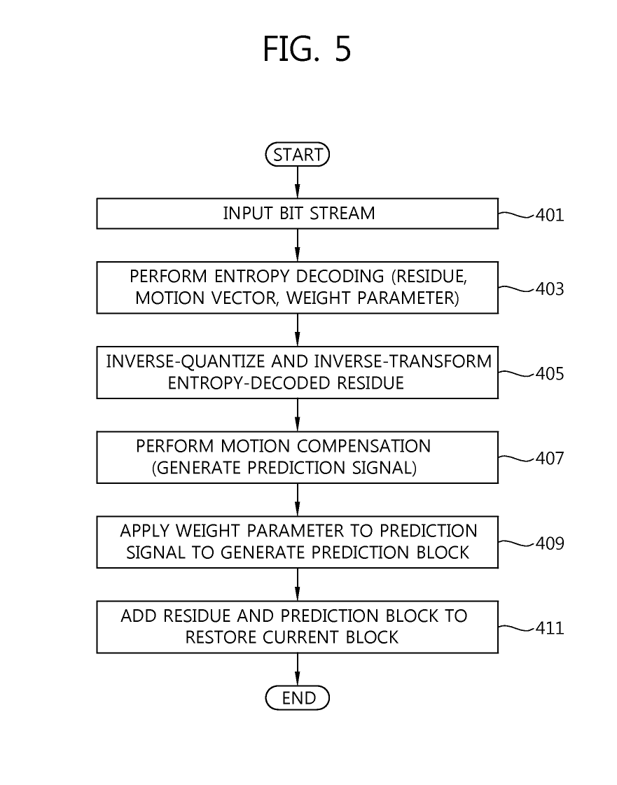

FIG. 5 is a flowchart illustrating an image decoding method using weighted prediction according to an embodiment of the present invention.

Referring to FIG. 5, the decoding apparatus receives the bit stream from the encoding apparatus (step 401) and performs entropy decoding on the received bit stream, thereby extracting the residue for the quantized coding unit to be currently decoded, the weight parameter, and motion vector (step 403).

Thereafter, the decoding apparatus performs inverse quantization and inverse transform on the decoded residue to thereby restore the residue (step 405).

Further, the decoding apparatus applies the entropy-decoded motion vector to the reference prediction unit of the reference picture that has been restored and stored in the buffer to thereby performing motion compensation, thus generating a prediction signal (step 407).

Then, the decoding apparatus multiplies the weight coefficient by the prediction signal generated through the motion compensation and adds the offset to thereby generate a prediction block (step 409), and adds the generated prediction block and the residue restored in step 405, thus restoring the current block (step 411).

The prediction-related information (motion vector, difference of the motion vector, residual value, etc.) is transmitted to the decoder for each prediction unit that is a basic unit for inter-frame prediction.

The partitioning for inter or intra-frame prediction may be implemented as asymmetric partitioning or geometrical partitioning having any other shape than square, or as partitioning along an edge direction.

In case of motion compensation inter-frame prediction, a motion vector (MV) is generated with one picture separated into plural blocks each having a predetermined size, and the generated motion vector is used to perform motion compensation. Since motion vectors may have non-integer values, motion compensation inter-frame prediction uses an interpolating filter so as to calculate sub-pixel values of the reference picture at the non-integer positions. That is, calculation of the sub-pixel values is done by performing filtering by applying the filter coefficient to pixels adjacent to the integer pixel of the reference picture. The higher order of filters is used, the better motion prediction performance may be achieved, but the amount of transmission of the filter coefficient of the interpolating filter to be transmitted to the decoder is also increased as much.

Accordingly, the method of adaptively using the interpolating filter according to the embodiments of the present invention selects and uses the interpolating filter on the basis more precise than the picture basis—for example, slice basis, prediction unit basis, or partition basis (the partition basis may include the extended macroblock, macroblock, or block) based on the experimental result that the optimal interpolating filter in one picture may vary depending on the region in the picture.

Hereinafter, sub-pixel value interpolation may apply to both luma and chroma components of an image. Here, for simplicity of description, interpolation of sub-pixel values only on the luma components described as an example.

Hereinafter, a method of performing encoding/decoding by selecting and using the interpolating filter used for motion compensation inter-frame prediction according to the embodiments of the present invention on the basis more precise than the picture basis—for example, slice basis, prediction unit basis, or partition basis (the partition basis may include the extended macroblock, macroblock, or block) will be specifically described.

FIG. 6 is a conceptual view for describing a process of selecting and using a filter on a per-slice basis according to an embodiment of the present invention.

Referring to FIG. 6, as a current picture Pt for time t, one optimal filter is selected and used among candidate filters—for example, three filters F1, F2, and F3—which belong to a candidate filter set (CFSt) at time t. The plural filters may be discerned by filter indexes. The filter indexes are identifiers to distinguish selected filters from each other. The filter indexes are included in filter information for selected filters and transmitted to the decoder. Hereinafter, the filter may be, e.g., the interpolating filter used for motion compensation inter-frame prediction.

Further, among the candidate filters—for example, three filters F1, F2, and F3—which belong to the candidate filter set (CFSt) at time t, one optimal filter may be selected and used on a per-slice basis in the current picture Pt at time t. That is, the optimal filter may be selected for each slice of the current picture Pt, and accordingly, the selected optimal filter may change depending on each slice (slice #0, slice #1, slice #2, . . . , slice #N) of the current picture Pt. For example, for slice #0 of the current picture Pt, among the candidate filters belonging to the candidate filter set CFSt, filter F1 may be selected, and for slice #1 of the current picture, among the candidate filters belonging to the candidate filter set CFSt, filter F2 may be selected. Or, the selected optimal filter may be the same for each slice of the current picture Pt. For example, for slice #0 of the current picture Pt, among the candidate filters belonging to the candidate filter set CFSt, filter F1 may be selected, and for slice #1 of the current picture, among the candidate filters belonging to the candidate filter set CFSt, filter F1 may be selected.

Per-slice optimal filter selection of the current picture may be done by selecting a filter among filters belonging to the candidate filter set CFS according to a rate-distortion optimization criterion.

Among candidate filters—e.g., three filters F1, F2, and F3—which belong to the candidate filter set CFSt, one optimal filter may be selected at time t on a per-slice basis in the current picture Pt for time t, so that filter information—filter index or filter coefficient—may be transmitted on the basis of a slice more precise than the picture basis, thus resulting in an increase in encoding accuracy.

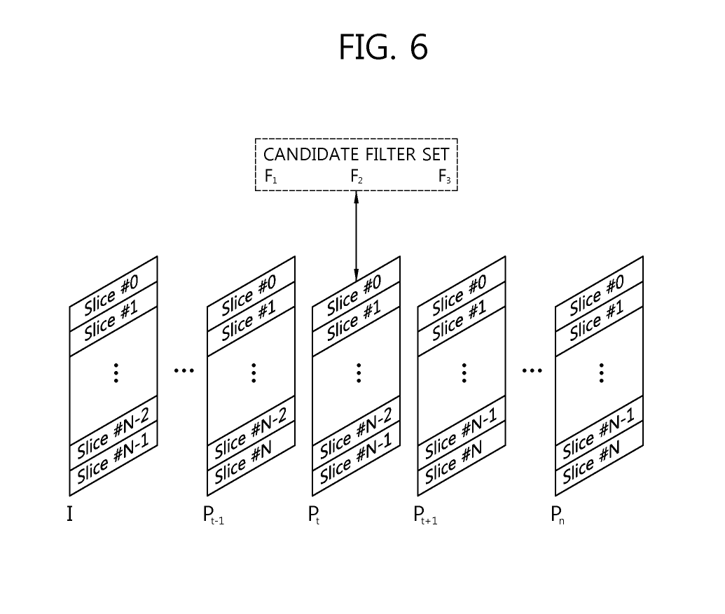

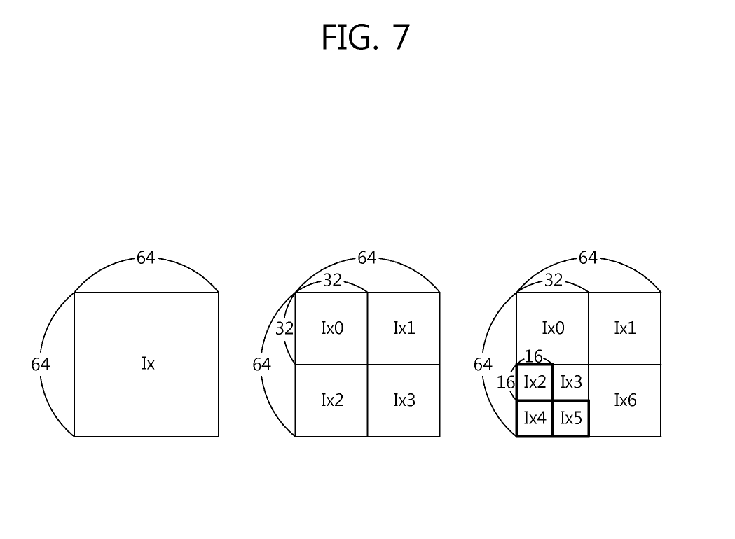

FIG. 7 is a conceptual view for describing a process of selecting and using a filter on a per-partition basis according to another embodiment of the present invention.

Here, the partition may include an extended macroblock (EMB), a macroblock (MB), or a block. The size of the extended macroblock means 32×32 pixels or more, and may include, e.g., 32×32 pixels, 64×64 pixels, or 128×128 pixels. The size of the macroblock may be, e.g., 16×16 pixels.

FIG. 7 illustrates an example where the partition is constituted of 64×64 pixels, 32×32 pixels, or 16×16 pixels and also illustrates a relationship between the partition and filter indexes. The leftmost view of FIG. 7 illustrates an example where a 64×64 partition is an extended macroblock having a size of 64×64 pixels, the central view of FIG. 7 illustrates an example where a 64×64 partition is divided into four partitions each having a size of 32×32 pixels—in other words, the 32×32 pixels sized partition is an extended macroblock having a 32×32 pixels size. The rightmost view of FIG. 7 illustrates an example where a 64×64 partiiton is divided into four 32×32 pixels sized partitions, and the left and lower 32×32 partition is divided again into four 16×16 partitions, wherein the 32×32 pixels sized partition is an extended macroblock having a size of 32×32 pixels, and the 16×16 pixels sized partition is a macroblock having a size of 16×16 pixels.

For example, the leftmost view of FIG. 7 represents an example where the 64×64 partition is selected as one 64×64 block through rate-distortion optimization, wherein one filter index Ix for the 64×64 partition is transmitted to the decoder.

For example, in case of the 64×64 partition shown in the central view of FIG. 7, one filter index for each of the four 32×32 partitions is transmitted to the decoder. Here, as illustrated in the central view of FIG. 7, different filter indexes (Ix0, Ix1, Ix2, Ix3) may be selected for the four 32×32 partitions, respectively, through rate-distortion optimization, and the same index may be selected for some or all of the four 32×32 partitions through rate-distortion optimization.

For example, in case of the 64×64 partition shown in the rightmost view of FIG. 7, one filter index for each of the three 32×32 partitions is transmitted to the decoder, and one filter index for each of the four 32×32 partitions is transmitted to the decoder, so that the maximum of 7 filter indexes may be used. Here, as shown in the central view of FIG. 7, different filter indexes (Ix0, Ix1, Ix6) for the three 32×32 partitions, respectively, may be selected through rate-distortion optimization, and the same filter index may be selected for some or all of the three 32×32 partitions through rate-distortion optimization.

In the case that the 64×64 partition is divided into 16 16×16 partitions, the maximum of 16 filter indexes may be used.

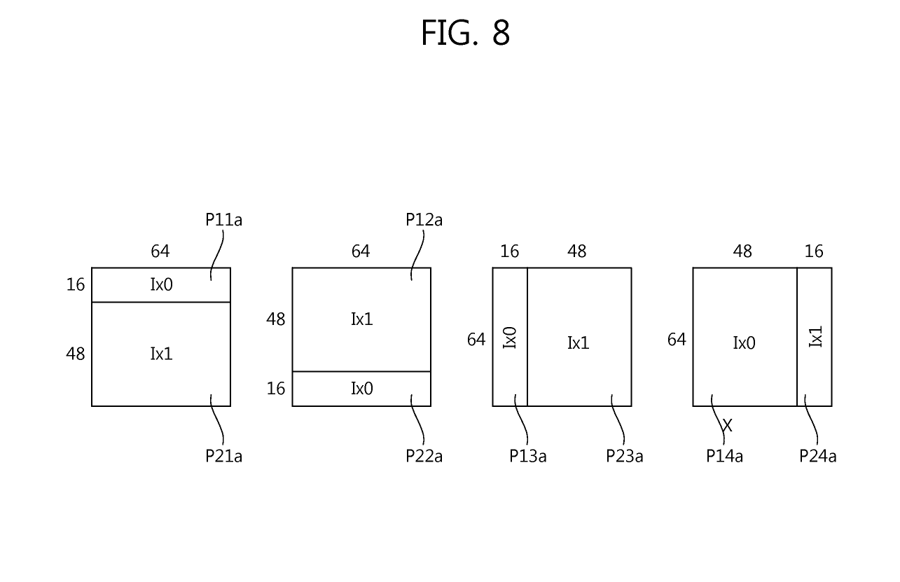

FIG. 8 is a conceptual view for describing a process of selecting and using a filter on the basis of asymmetric partitioning according to another embodiment of the present invention.

In the case that the size of the prediction unit PU for inter or intra-frame prediction is M×M (M is a natural number whose unit is pixels), asymmetric partitioning may be performed in a horizontal or vertical direction of the coding unit. FIG. 8 illustrates an example where the size of the prediction unit PU is, e.g., 64×64.

Referring to FIG. 8, asymmetric partitioning is conducted in the horizontal direction to thereby divide the partition into a partition P11a having a size of 64×16 pixels and a partition P21a having a size of 64×48 pixels, or into a partition P12a having a size of 64×48 pixels and a partition P22a having a size of 64×16 pixels. Further, asymmetric partitioning may be conducted in the vertical direction to thereby divide the partition into a partition P13a having a size of 16×64 pixels and a partition P23a having a size of 48×64 pixels or into a partition P14a having a size of 48×64 pixels and a partition P24a having a size of 16×64 pixels.

For each of the 64×16 partition, the 64×48 partition, the 16×64 partition, and the 48×64 partition shown in FIG. 8, one filter index is transmitted to the decoder. Here, for each of the 64×16 partition, the 64×48 partition, the 16×64 partition, and the 48×64 partition in the 64×64 partition, a different filter index may be selected through rate-distortion optimization, or the same filter index may be selected for all the partitions.

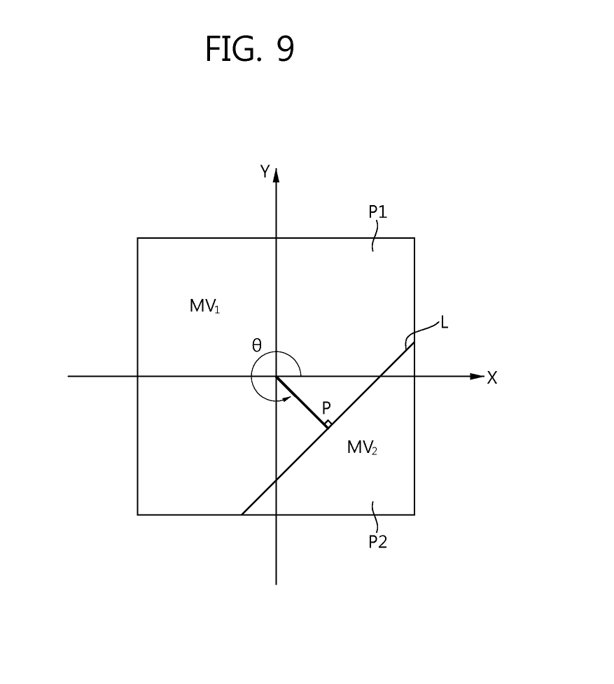

FIG. 9 illustrates an example where geometric partitioning having a shape other than square is performed on the prediction unit according to an embodiment of the present invention.

Referring to FIG. 9, the border line L of the geometrical partition for the prediction unit PU may be defined as follows. With respect to the center O of the prediction unit PU, the prediction unit PU is divided into four quadrants by X and Y axes, and a vertical line is drawn from the center O of the prediction unit PU to the border line L, so that all border lines positioned in any direction may be specified by a vertical distance p between the center O of the prediction unit PU and the border line L and a rotation angle θ counterclockwise from the X axis to the vertical line.

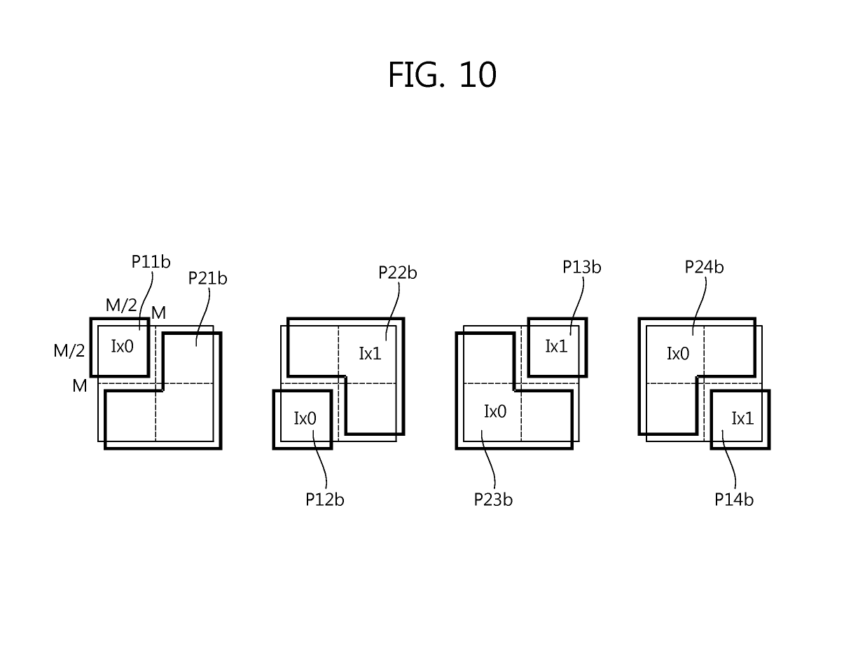

FIG. 10 is a conceptual view for describing a process of selecting and using a filter on the basis of a geometrical partition having a shape other than square according to another embodiment of the present invention.

Referring to FIG. 10, the prediction unit PU for inter or intra-frame prediction is divided into four quadrants with respect to the center, and is thus split into a partition P11b which is the upper and left block in the second quadrant and a partition P21b which has a shape of ‘┘’ in the remaining first, third, and fourth quadrants. Or, the prediction unit PU may be split into a partition P12b which is the lower and left block in the third quadrant and a partition P22b which is the block in the remaining first, second, and fourth quadrants. Or, the prediction unit PU may be split into a partition P13b which is the upper and right block in the first quadrant and a partition P23b which is the block in the remaining second, third, and fourth quadrants. Or, the prediction unit PU may be split into a partition P14b which is the lower and right block in the fourth quadrant and a partition P24b which is the block in the remaining first, second, and third quadrants.

Partitioning is done in the shape of ‘┐’ as described above, so that the in the case that a moving object is present in the edge block, i.e., the upper and left, lower and left, and lower and right blocks upon partitioning, more effective encoding may be achieved than when partitioning is performed to four blocks. According to an edge block in which the moving object is positioned among the four partitions, a corresponding partition may be selected and used.

Referring to FIG. 10, one filter index for each geometrical partition may be sent to the decoder. Here, a different filter index for each geometrical partition may be selected through rate-distortion optimization, or the same filter index for all the geometrical partitions may be selected.

FIG. 11 is a conceptual view for describing a process of selecting and using a filter on the basis of a geometrical partition having a shape other than square according to another embodiment of the present invention.

Referring to FIG. 11, the prediction unit PU for inter or intra-frame prediction is split into two different irregular regions (modes 0 and 1) or may be split into rectangular regions having different sizes (modes 2 and 3).

Here, parameter ‘pos’ is used to indicate the position of a partition border. In case of modes 0 and 1, ‘pos’ refers to a distance between a diagonal line of the prediction unit PU to the partition border, and in case of modes 2 and 3, ‘pos’ refers to a horizontal distance from a vertical bisecting line or horizontal bisecting line of the prediction unit PU to the partition border. In case of the example of FIG. 11, mode information may be transmitted to the decoder. Among the four modes, a mode exhibiting the minimum RD cost in terms of RD (Rate Distortion) may be used for inter-frame prediction.

Referring to FIG. 11, one filter index for each geometrical partition may be sent to the decoder. Here, a different filter index for each geometrical partition may be selected through rate-distortion optimization or the same filter index for all the geometrical partitions may be selected.

After partitioning, the size of the block may vary. Further, after partitioning, the block may have various shapes, such as an asymmetric shape, e.g., a rectangle, ‘┐’, or triangle, as illustrated in FIGS. 8 to 11, as well as square in the conventional art.

In case of high-resolution images having an HD or higher resolution, upon motion compensation inter-frame prediction, the unit in which the filter information—filter index or filter coefficient—of the interpolating filter is sent may be adaptively adjusted to a more precise basis—slice basis, or prediction unit basis or (extended) macroblock basis or partition basis—than the picture basis so as to increase prediction performance upon motion compensation inter-frame prediction, thereby lifting coding efficiency.

In case of high-resolution images having an HD or higher resolution, the number of blocks per picture increases, so that when the filter coefficient for each partition is transmitted to the decoder, the amount of filter information transmitted sharply increases, and this is not good in terms of coding efficiency. Accordingly, in the case that the partition basis is used as a unit of information transmission of the filter information of the interpolating filter used for motion compensation inter-frame prediction, block merging is used so that the whole merged block is used as a unit of transmission to thereby reduce the amount of additional information to be transmitted to the decoder, thus resulting in an increase in encoding efficiency of high-resolution images having an HD or Ultra HD or higher resolution.

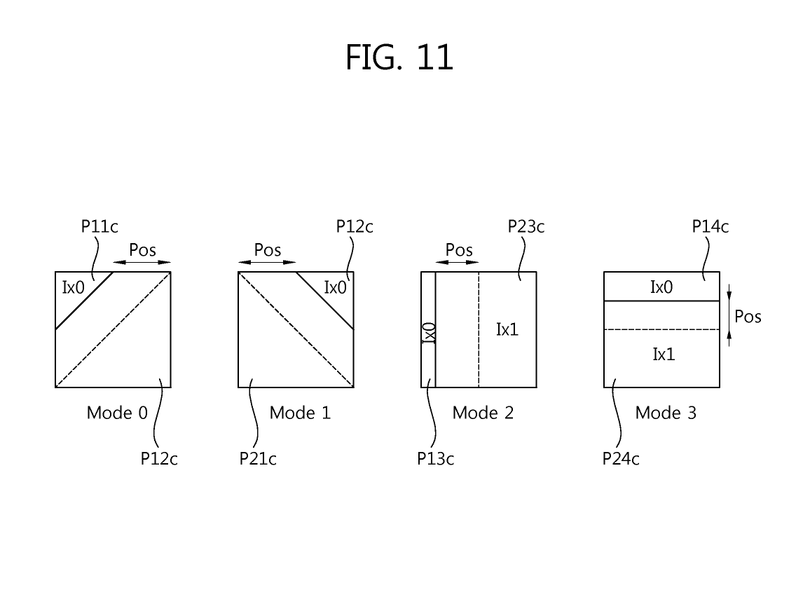

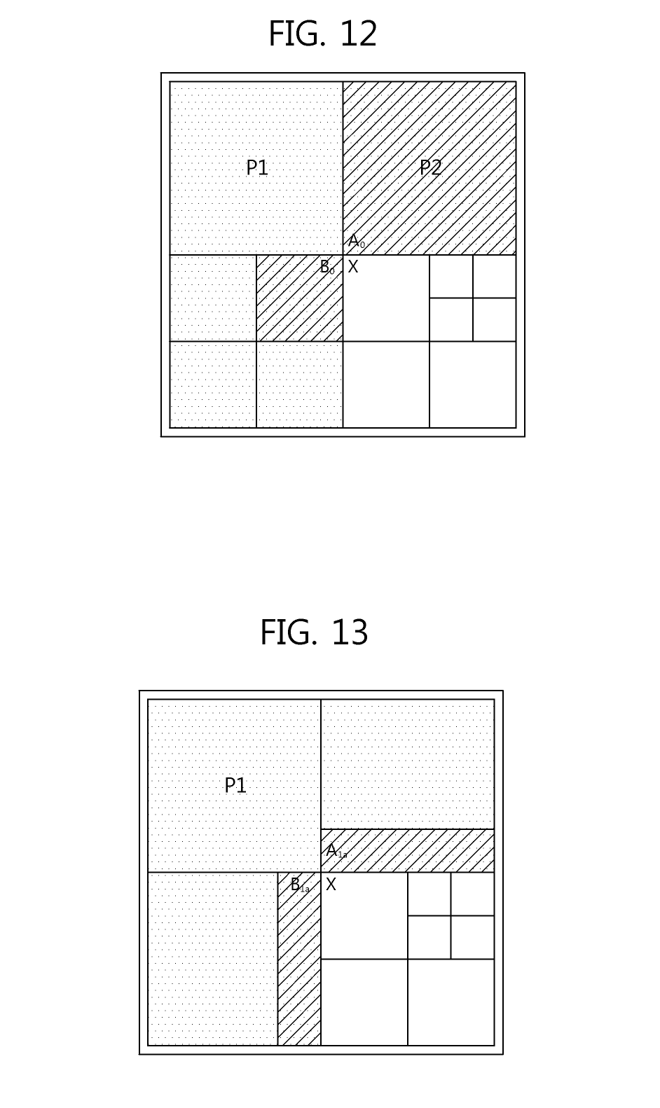

FIG. 12 is a conceptual view for describing an encoding method using block merging according to an embodiment of the present invention.

Referring to FIG. 12, one picture is hierarchically split to the leaf coding unit, and then the current block X is merged with blocks Ao and Bo previously encoded, so that the blocks Ao, Bo, and X are transmitted to the decoder while applied with the same motion parameter. Here, the motion parameter may include, e.g., a motion vector, a motion vector difference value, etc.

In such case, a merging flag indicating whether block merging has applied may be sent to the decoder.

Hereinafter, in case of inter-frame prediction, a set of all the prediction blocks is defined as a “temporary block”, and a set of blocks allowed to merge with a specific block is defined as a “merged block”. The temporary block includes blocks encoded until before the current block. The reference of the mergeable blocks may be predetermined as two blocks, such as top side adjacent block and left side adjacent block of the current block or top side adjacent samples and left side adjacent samples of the current block. Or, the reference of the mergeable blocks may be predetermined as two or more blocks, for example, all the top side adjacent blocks and all the left side adjacent blocks.

The reference of the mergeable block may be predetermined by an agreement between the encoder and decoder. For example, as described above, the top side adjacent samples and left side adjacent samples of the current block may be determined as a default without separate information indicating the reference of the mergeable blocks being transferred to the decoder. Or, information indicating the reference of the mergeable blocks may be sent to the decoder as well.

If a specific block is encoded and the mergeable block is not empty, information on whether this mergeable block is to be merged may be sent to the decoder.

A set of mergeable blocks may have maximally, e.g., two elements (the above-mentioned two sample positions, i.e., the left side adjacent sample position and the top side adjacent sample position). However, the mergeable block set is not limited as necessarily having two candidate sample positions or two candidate blocks but may have two or more candidate sample positions or candidate blocks. Hereinafter, an example where the mergeable block set has two candidate blocks will be described with reference to FIG. 12.

FIG. 12 illustrates an example where one picture is split into prediction blocks in a quadtree-based division manner. In FIG. 12, the two largest blocks P1 positioned at the top side of FIG. 12 are macroblocks, which are the largest prediction blocks. The remaining blocks shown in FIG. 12 are obtained by performing subdivision on the corresponding macroblock. The current block is marked with ‘X’. The regions denoted in dotted lines in FIGS. 12 to 19 refer to blocks encoded before the current block X and may be the above-described temporary blocks.

The mergeable block may be generated as follows.

Starting from the top-left sample position of the current block, the left-side adjacent sample position and the top-side adjacent sample position of the current block become candidate block positions for block merging. In the case that the set of mergeable block is not empty, a merging flag to indicate that the current block is merged with the mergeable block is transmitted to the decoder. Otherwise, that is, when the merging flag is ‘0’ (false), this means that there is no mergeable block, and the motion parameters are transmitted to the decoder with block merging not performed with any of the temporary blocks.

If the merging flag is ‘1’ (true), the following operation is performed. If the set of mergeable block includes only a single block, the block included in the mergeable block set is used for block merging. If the set of mergeable block includes two blocks whose motion parameters are the same as each other, the motion parameters of the two blocks included in the mergeable block set are used for the current block as well. For example, when merge_left_flag is ‘1’ (true), among the top-left side sample positions for the current block X in the mergeable block set, the left-side adjacent sample position may be selected, and when merge_left_flag is ‘0’ (false), among the top-left side sample positions for the current block X in the mergeable block set, the other top-side adjacent sample position may be selected. The motion parameters for the above-selected blocks are also used for the current block.

Referring to FIG. 12, the blocks (blocks ‘Ao’ and ‘Bo’) including directly adjacent samples among the top-left side sample positions may be included in the mergeable block set. Accordingly, the current block X is merged with block Ao or Bo. If merge_flag is 0 (false), the current block X is not merged with block Ao nor block Bo. If blocks Ao and Bo have the same motion parameter, the same result is obtained irrespective of whether merging is done with block Ao or Bo, and thus, it is not necessary to discern the two blocks Ao and Bo. Thus, in such case, it is not required to transmit merge_left_flag. Otherwise, i.e., when blocks Ao and Bo have different motion parameters, if merge_left_flag is 1, the current block X is merged with block Bo, and if merge_left_flag is 0, the current block X is merged with block Ao.

FIGS. 13 to 15 are conceptual views for describing an encoding method using in case of asymmetric partitioning according to another embodiment of the present invention. FIGS. 13 to 15 illustrate three examples of block merging in the case that geometrical partitioning of FIG. 8 is used for intra-frame prediction. However, the present invention is not limited to those illustrated in FIGS. 13 to 15, and the block merging according to another embodiment of the present invention may also apply to combinations of various partitioning methods illustrated in FIG. 8.

Referring to FIG. 13, blocks (blocks ‘A1a’ and ‘B1a’) including top side or left side adjacent samples among the top-left side sample positions of the current block X may be included in the mergeable block set. Accordingly, the current block X is merged with block A1a or B1a. If merge_flag is 0 (false), the current block X is not merged with block A1a nor block B1a. For example, if merge_left_flag is ‘1’ (true), among the top-left side sample positions for the current block X in the mergeable block set, block B1a including the left side adjacent samples may be selected to be merged with the current block X, and if merge_left_flag is ‘0’ (false), among the top-left side sample positions for the current block X in the mergeable block set, block A1a including the other top side adjacent samples may be selected to be merged with the current block X.

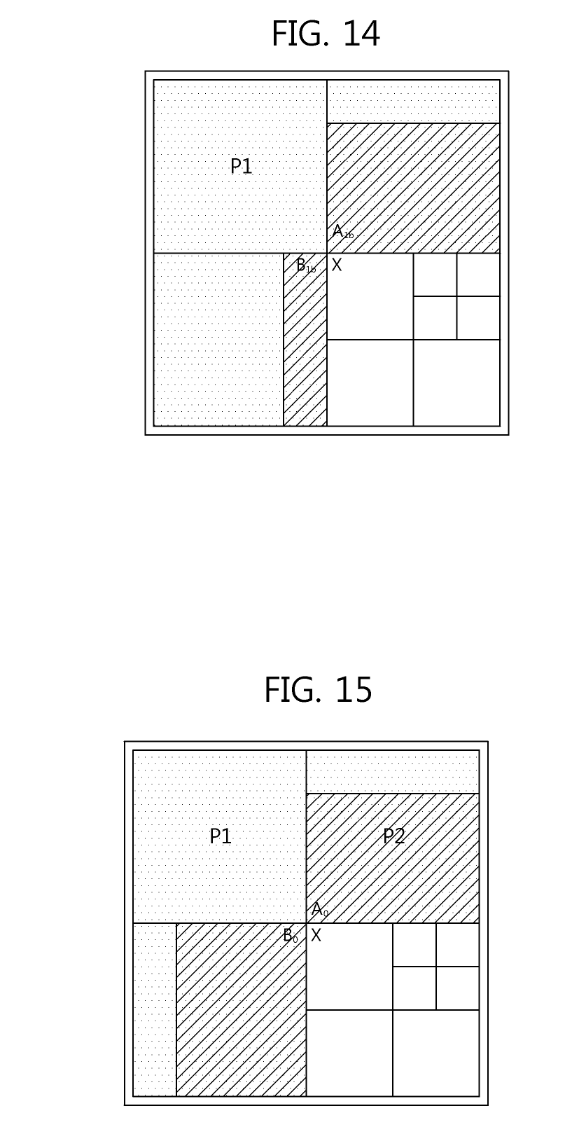

Referring to FIG. 14, the current block X is merged with block A1b or B1b that belongs to the mergeable block set. If merge_flag is 0 (false), the current block X is not merged with block A1b nor block B1b. If merge_left_flag is ‘1’, block B1b in the mergeable block set may be selected to be merged with the current block X, and if merge_left_flag is ‘0’ (false), block A1b may be selected to be merged with the current block X.

Referring to FIG. 15, the current block X is merged with block A1c or B1c that belongs to the mergeable block set. If merge_flag is 0 (false), the current block X is not merged with block A1c nor block B1c. If merge_left_flag is ‘1’ (true), block B1c in the mergeable block set may be selected to be merged with the current block X, and if merge_left_flag is ‘0’ (false), block A1c may be selected to be merged with the current block X.

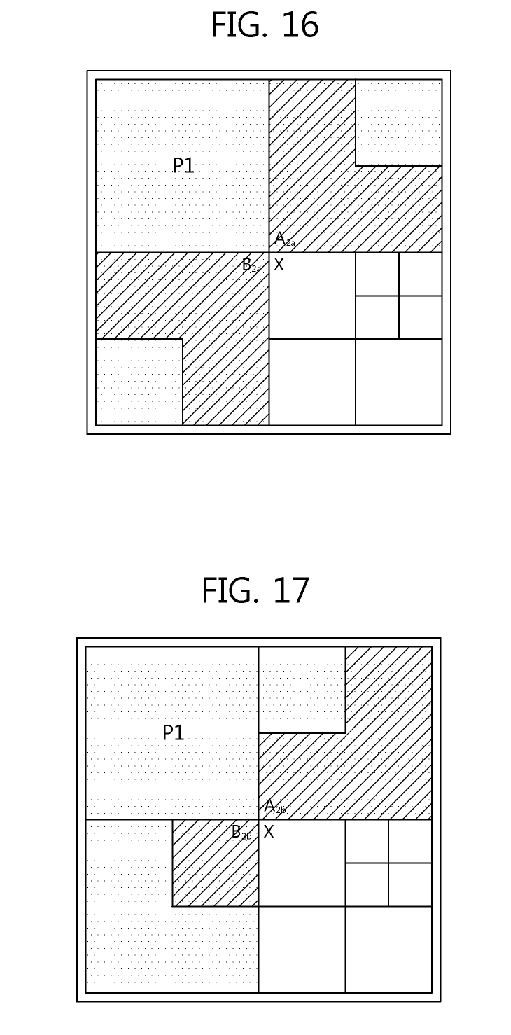

FIGS. 16 and 17 are conceptual views for describing an encoding method using block merging in case of geometrical partitioning according to another embodiment of the present invention. FIGS. 16 and 17 illustrate two examples of block merging in the case that geometrical partitioning illustrated in FIG. 10 is used for inter-frame prediction. However, the present invention is not limited to those illustrated in FIGS. 16 and 17, and the block merging according to another embodiment of the present invention may also apply to combinations of various partitioning methods illustrated in FIG. 10.

Referring to FIG. 16, blocks (blocks ‘A2a’ and ‘B2a’) including top side or left side adjacent samples among the top-left side sample positions of the current block X may be included in the mergeable block set. Accordingly, the current block X is merged with block A2a or B2a. If merge_flag is 0 (false), the current block X is not merged with block A2a nor block B2a. For example, if merge_left_flag is ‘1’ (true), among the top-left side sample positions for the current block X in the mergeable block set, block B2a including the left side adjacent samples may be selected to be merged with the current block X, and if merge_left_flag is ‘0’ (false), among the top-left side sample positions for the current block X in the mergeable block set, block A2a including the other top side adjacent samples may be selected to be merged with the current block X.

Referring to FIG. 17, the current block X is merged with block A2b or B2b that belongs to the mergeable block set. If merge_flag is 0 (false), the current block X is not merged with block A2b nor block B2b. If merge_left_flag is ‘1’ (true), block B2b in the mergeable block set may be selected to be merged with the current block X, and if merge_left_flag is ‘0’ (false), block A2b may be selected to be merged with the current block X.

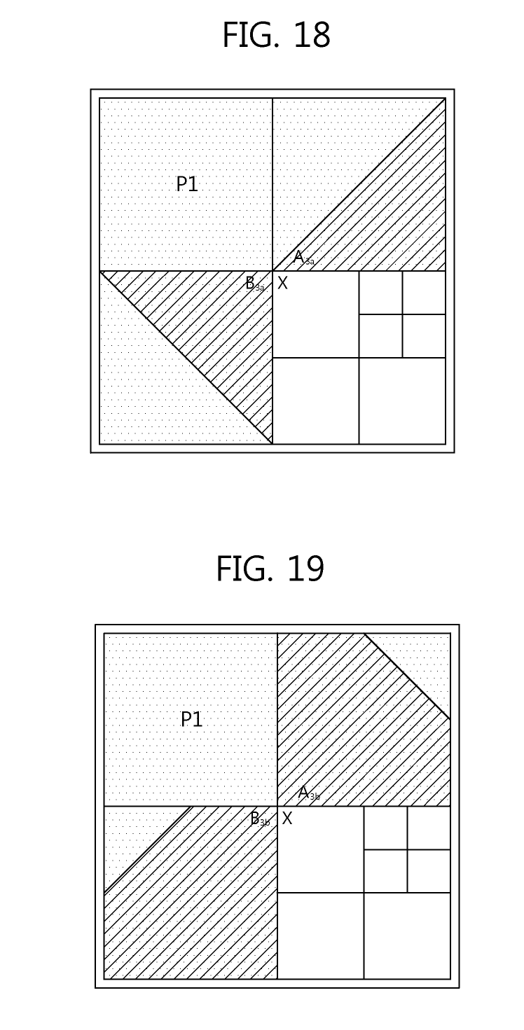

FIGS. 18 and 19 are conceptual views for describing an encoding method using block merging in case of geometrical partitioning according to another embodiment of the present invention. FIGS. 18 and 19 illustrate two examples of block merging in the case that geometrical partitioning illustrated in FIGS. 9 and 11 are used for inter-frame prediction. However, the present invention is not limited to those illustrated in FIGS. 6a to 6b, and the block merging according to another embodiment of the present invention may also apply to combinations of various geometrical partitioning methods illustrated in FIGS. 9 and 11.

Referring to FIG. 18, blocks (blocks ‘A3a’ and ‘B3a’) including top side or left side adjacent samples among the top-left side sample positions of the current block X may be included in the mergeable block set. Accordingly, the current block X is merged with block A3a or B3a. If merge_flag is 0 (false), the current block X is not merged with block A3a nor block B3a. For example, if merge_left_flag is ‘1’ (true), among the top-left side sample positions for the current block X in the mergeable block set, block B3a including the left side adjacent samples may be selected to be merged with the current block X, and if merge_left_flag is ‘0’ (false), among the top-left side sample positions for the current block X in the mergeable block set, block A3a including the other top side adjacent samples may be selected to be merged with the current block X.

Referring to FIG. 19, the current block X is merged with block A3b or B3b. If merge_flag is 0 (false), the current block X is not merged with block A3b nor block B3b. If merge_left_flag is 1 (true), block B3b in the mergeable block set may be selected to be merged with the current block X, and if merge_left_flag is ‘0’ (false), block A3b may be selected to be merged with the current block X.

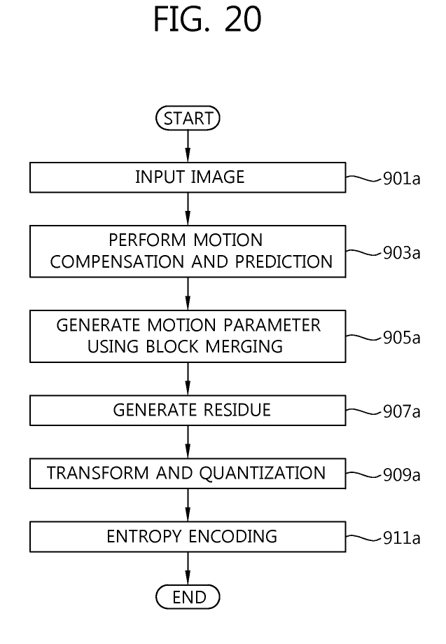

FIG. 20 is a flowchart illustrating an image encoding method using block merging according to an embodiment of the present invention.

Referring to FIG. 20, if an input image is input to the encoding apparatus (step 901a), the prediction unit for inter or intra-frame prediction on the input image is split by the above-described various partitioning methods, and a region similar to the partitioned block currently encoded in at least one reference picture (which has been encoded and stored in the frame buffer 651) positioned before and/or behind the picture currently encoded for each partitioned block is searched to thereby generate the motion vector on a per-block basis, and the generated motion vector and picture are used to perform motion compensation, thereby generating the prediction block (or predicted prediction unit) (step 903a).

Then, the encoding apparatus performs the above-mentioned block merging on the partitioned prediction unit PU to thereby generate the motion parameter for each merged block (step 905a). The per-block motion parameter merged by performing the above-described block merging is sent to the decoder.

The encoding apparatus obtains a different between the current prediction unit and the predicted prediction unit to thereby generate the residue (step 907a).

Thereafter, the encoding apparatus transforms and quantizes the generated residue (step 909a) and entropy-encodes the header information, such as the quantized DCT coefficients and motion parameter, thereby generating a bit stream (step 911a).

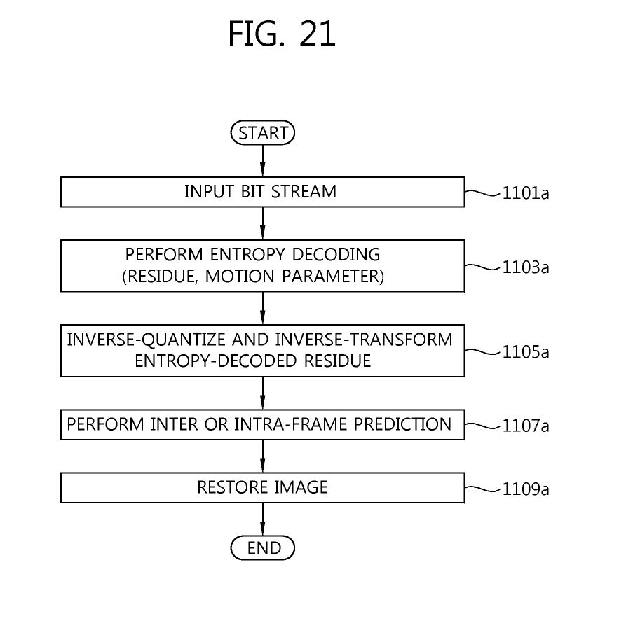

In the image encoding/decoding method using block merging according to the embodiments of the present invention, without motion parameter for each prediction block being transmitted, block merging is used so that the motion parameter is once transmitted for the whole merged block to thereby reduce the amount of transmission of the motion parameter, thus increasing encoding efficiency of high-definition images having a HD, ultra HD or higher resolution. FIG. 21 is a flowchart illustrating an image decoding method according to an embodiment of the present invention.

Referring to FIG. 21, the decoding apparatus receives the bit stream from the encoding apparatus (step 1110a).

Thereafter, the decoding apparatus performs entropy decoding (step 1103a). The data decoded through entropy decoding includes the residue that represents a difference between the current prediction unit and the predicted prediction unit. The header information decoded through the entropy decoding may include additional information, such as prediction unit information and motion parameters for motion compensation and prediction. The prediction unit information may include information on the prediction unit size. The motion parameter may include a motion parameter transmitted from each block merged by the block merging method according to the embodiments of the present invention.

Here, in the case that instead of performing encoding and decoding using the extended macroblock and the size of the extended macroblock, the above-described recursive coding unit (CU) is used to conduct encoding and decoding, the prediction unit (PU) information may include the size of the largest coding unit (LCU), the size of the smallest coding unit (SCU), the maximally allowable hierarchical level or hierarchical depth, and flag information.

A decoding controller (not shown) may receive information on the size of the prediction unit (PU) that has applied in the encoding apparatus and may perform motion compensation decoding, inverse transform, or inverse quantization, which will be described later, according to the size of the prediction unit (PU) that has applied in the decoding apparatus.

The decoding apparatus inverse-quantizes and inverse-transforms the entropy-decoded residue (step 1105a). The inverse transform process may be performed on the basis of the prediction unit size (for example, 32×32 or 64×64 pixels).

The decoding apparatus performs inter or intra-frame prediction using the previously restored picture, the motion parameter for motion compensation and prediction, and the prediction unit size information to thereby generate a predicted prediction unit (step 1107a). The decoding apparatus performs inter or intra-frame prediction using the prediction unit size information and the motion parameter transmitted for each block merged by the block merging method according to the embodiments of the present invention.

The decoder adds the inverse-quantized and inverse-transformed residue and the prediction unit predicted through the inter or intra-frame prediction to thereby restore the image (step 1109a).

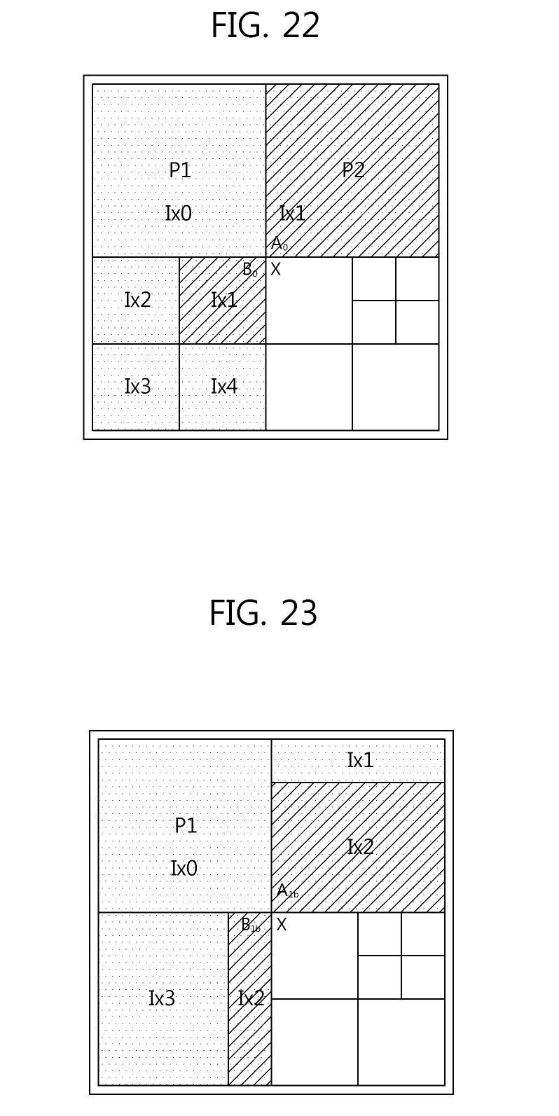

FIG. 22 is a conceptual view for describing a process of selecting and using a filter on a per-partition basis using block merging according to another embodiment of the present invention.

Referring to FIG. 22, after one picture is hierarchically split up to the leaf coding unit, the current block X is merged with the previously encoded blocks Ao and Bo, and blocks Ao, Bo, X are applied with the same motion parameter and/or filter information and transmitted to the decoder. Here, the motion parameter may include, e.g., motion vectors, motion vector difference values, residual values, etc. The filter information may include filer index and/or filter coefficient.

In such case, a merging flag indicating whether block merging has applied may be transmitted to the decoder.

Hereinafter, in case of inter-frame prediction, a set of all the prediction blocks is defined as a “temporary block”, and a set of blocks allowed to merge with a specific block is defined as a “mergeable block”. The temporary block includes blocks encoded until before the current block. As a reference of the mergeable blocks, for example, samples adjacent to the top and left sides of the current block or two blocks, such as blocks adjacent to the top and left sides of the current block, may be previously set. Or, as the reference of the mergeable blocks, two or more blocks, for example, all the blocks adjacent to the top side of the current block and all the blocks adjacent to the left side of the current block may be previously set.

The reference of the mergeable blocks may be previously defined according to an agreement between the encoder and the decoder. For example, as a default, the samples adjacent to the top and left sides of the current block, as described above, are determined, and separate information to indicate a reference of the mergeable blocks may not be transmitted to the decoder. Or, the information to indicate the reference of the mergeable blocks may be sent to the decoder.

If a specific block is encoded and the mergeable block is not empty, information on whether this mereable block is to be merged may be transmitted to the decoder.

The set of the mergeable blocks may have, for example, maximally two elements (the two sample positions, i.e., left-side and top-side adjacent sample positions). However, the set of mergeable blocks is not limited as necessarily having two candidate sample positions or two candidate blocks, and may have two or more candidate sample positions or candidate blocks. Hereinafter, an example where the set of mergeable blocks has two candidate blocks is described with reference to FIG. 22.

FIG. 22 illustrates an example where one picture is split into prediction blocks in a quadtree-based division manner. Two largest blocks P1 and P2 positioned at an upper side of FIG. 22 are macroblocks that are the largest prediction blocks. The remaining blocks in FIG. 22 are obtained by performing subdivision on the macroblocks. The current block is denoted with ‘X’. The regions indicated in dotted lines in FIGS. 22 to 27 refer to blocks encoded before the current block X and may be the above-described “temporary blocks”.

The mergeable block may be generated as follows.

Starting from the top-left sample position of the current block, the left-side adjacent sample position and the top-side adjacent sample position of the current block become candidate block positions for block merging. In the case that the set of mergeable block is not empty, a merging flag to indicate that the current block is merged with the mergeable block is transmitted to the decoder. Otherwise, that is, when the merging flag is ‘0’ (false), this means that there is no mergeable block, and the motion parameters are transmitted to the decoder with block merging not performed with any of the temporary blocks.

If the merging flag is ‘1’ (true), the following operation is performed. If the set of mergeable block includes only a single block, the block included in the mergeable block set is used for block merging. If the set of mergeable block includes two blocks whose motion parameters are the same as each other, the motion parameters of the two blocks included in the mergeable block set are used for the current block as well. For example, when merge_left_flag is ‘1’ (true), among the top-left side sample positions for the current block X in the mergeable block set, the left-side adjacent sample position may be selected, and when merge_left_flag is ‘0’ (false), among the top-left side sample positions for the current block X in the mergeable block set, the other top-side adjacent sample position may be selected. The motion parameters for the above-selected blocks are also used for the current block.

Turning back to FIG. 22, the blocks (blocks ‘Ao’ and ‘Bo’) including directly adjacent samples among the top-left side sample positions may be included in the mergeable block set. Accordingly, the current block X is merged with block Ao or Bo. If merge_flag is 0 (false), the current block X is not merged with block Ao nor block Bo. If blocks Ao and Bo have the same motion parameter and/or filter information, the same result is obtained irrespective of whether merging is done with block Ao or Bo, and thus, it is not necessary to discern the two blocks Ao and Bo. Thus, in such case, it is not required to transmit merge_left_flag. Otherwise, i.e., when blocks Ao and Bo have different motion parameters and/or filter information, if merge_left_flag is 1, the current block X is merged with block Bo, and if merge_left_flag is 0, the current block X is merged with block Ao.

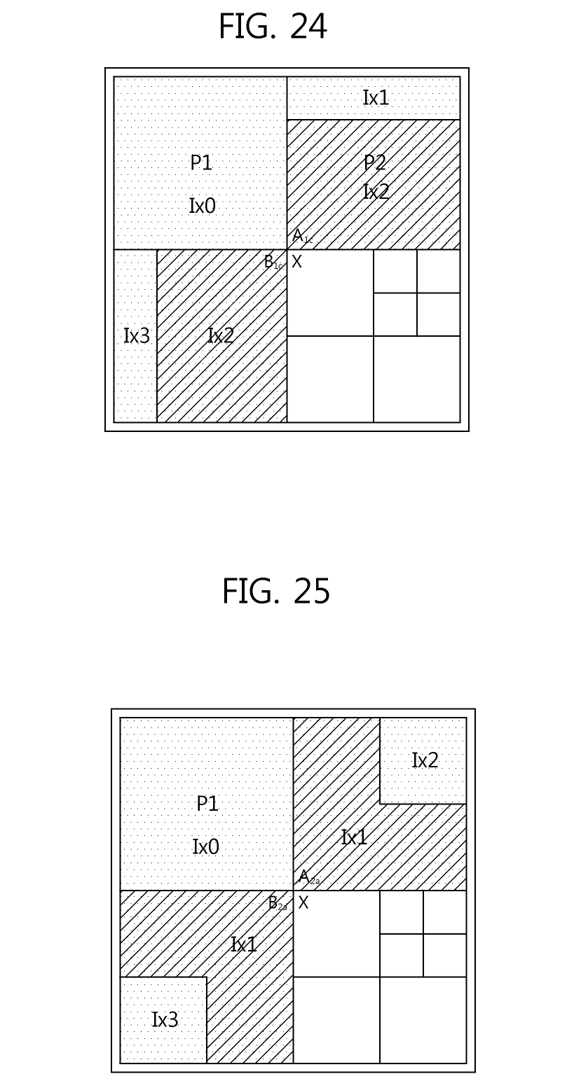

FIGS. 23 and 24 are conceptual views for describing a process of selecting and using a filter on a per-partition basis using block merging in case of asymmetric partitioning according to another embodiment of the present invention.

FIGS. 23 and 24 illustrate two examples of block merging performed when asymmetric partitioning illustrated in FIG. 8 is used upon inter-frame prediction. However, the invention is not limited to those illustrated in FIGS. 23 and 24, and the block merging according to another embodiment of the present invention may also apply to combinations of various partitioning methods illustrated in FIG. 8.

Referring to FIG. 23, the current block X is merged with block A1b or B1b that belongs to the mergeable block set. If merge_flag is 0 (false), the current block X is not merged with block A1b nor block B1b. If merge_left_flag is ‘1’ (true), block B1b in the mergeable block set may be selected to be merged with the current block X, and if merge_left_flag is ‘0’ (false), block A1b may be selected to be merged with the current block X.

Referring to FIG. 24, the current block X is merged with block A1c or B1c that belongs to the mergeable block set. If merge_flag is 0 (false), the current block X is not merged with block A1c nor block B1c. If merge_left_flag is ‘1’ (true), block B1c in the mergeable block set may be selected to be merged with the current block X, and if merge_left_flag is ‘0’ (false), block A1c may be selected to be merged with the current block X.

Referring to FIGS. 23 and 24, the same filter is selected for the block-merged asymmetric partitions is selected and the same filter information may be transmitted to the decoder. For example, in case of the example of FIG. 23, the same filter index Ix2 for the merged asymmetric partitions A1b and B1b may be transmitted to the decoder. In case of the example of FIG. 24, the same filter index Ix2 for the merged asymmetric partitions A1c and B1c may be transmitted to the index Ix2.

FIG. 25 is a conceptual view for describing a process of selecting and using a filter on a per-partition basis using block merging in case of geometrical partitioning according to another embodiment of the present invention.

FIG. 25 illustrates an example of block merging when geometrical partitioning of FIG. 10 is used for inter-frame prediction, and the invention is not limited to what is illustrated in FIG. 25. The block merging according to another embodiment of the present invention may also apply to combinations of the various partitioning methods shown in FIG. 10.

Referring to FIG. 25, among the top-left side sample positions of the current block X, blocks (blocks ‘A2a’ and ‘B2a’) including the top or left side adjacent samples may be included in the mergeable block set. Accordingly, the current block X is merged with block A2a or B2a. If merge_flag is 0 (false), the current block X is not merged with block A2a nor block B2a. For example, in the case that merge_left_flag is ‘1’ (true), among the top-left side sample positions for the current block X in the mergeable block set, block B2a including the left side adjacent samples may be selected to be merged with the current block X, and in the case that merge_left_flag is ‘0’ (false), among the top-left side sample positions for the current block X in the mergeable block set, block A2a including the other top side adjacent samples may be selected to be merged with the current block X.

Referring to FIG. 25, the same filter for the block-merged geometrical partitions may be selected and the same filter information may be sent to the decoder. For example, in case of the example illustrated in FIG. 25, the same index Ix1 for the merged geometrical partitions A2a and B2a may be transferred to the decoder.

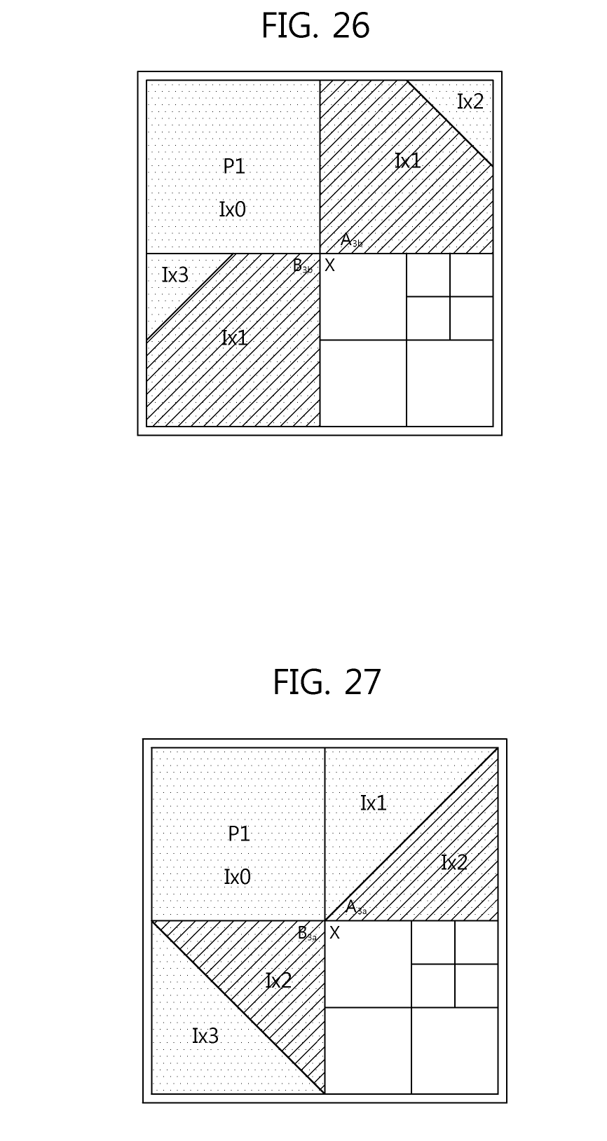

FIGS. 26 and 27 are conceptual views for describing a process of selecting and using a filter on a per-partition basis using block merging in case of geometrical partitioning according to another embodiment of the present invention.

FIGS. 26 and 27 illustrate two examples of block merging in case of using the geometrical partitioning illustrated in FIGS. 9 and 11 upon inter-frame prediction. However, the present invention is not limited to those illustrated in FIGS. 26 and 27, and the block merging according to another embodiment of the present invention may also apply to combinations of various geometrical partitioning methods shown in FIGS. 9 and 11.

Referring to FIG. 26, among the top-left side sample positions of the current block X, blocks (blocks ‘A3a’ and ‘B3a’) including the top or left side adjacent samples may be included in the mergeable block set. Accordingly, the current block X is merged with block A3a or B3a. If merge_left_flag is 0 (false), the current block X is not merged with block A3a nor block B3a. for example, in the case that merge_left_flag is ‘1’ (true), among the top-left sample positions for the current block X in the mergeable block set, block B3a including the left side adjacent samples may be selected to be merged with the current block X, and in the case that merge_left_flag is ‘0’ (false), among the top-left sample positions for the current block X in the mergeable block set, block A3a including the other top side adjacent samples may be selected to be merged with the current block X.

Referring to FIG. 27, the current block X is merged with block A3b or B3b that belongs to the mergeable block set. If merge_flag is 0 (false), the current block X is not merged with block A3b nor block B3b. In the case that merge_left_flag is ‘1’ (true), block B3b in the mergeable block set may be selected to be merged with the current block X, and in the case that merge_left_flag is ‘0’ (false), block A3b may be selected to be merged with the current block X.

Referring to FIGS. 26 and 27, the same filter for the block merged geometrical partitions may be selected and the same filter information may be sent to the decoder. For example, the same filer index Ix2 for the merged geometrical partitions A3a and B3a in case of the example of FIG. 26 may be transmitted to the decoder. For example, in case of the example of FIG. 27, the same filter index Ix1 for the merged geometrical partitions A3b and B3b may be sent to the decoder.

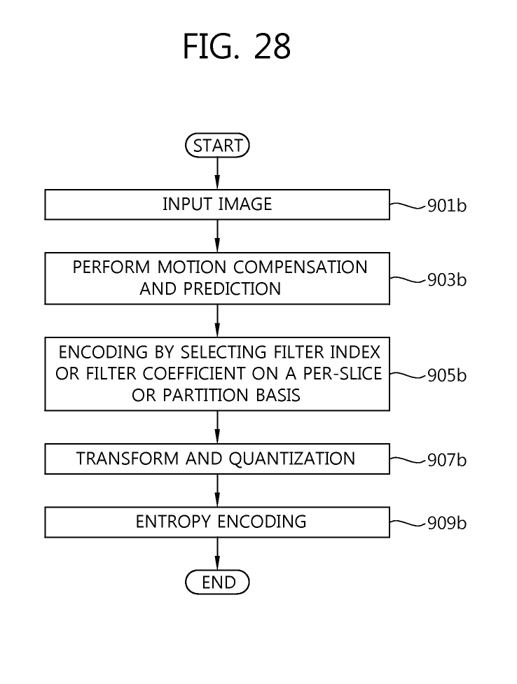

FIG. 28 is a flowchart illustrating an image encoding method for selecting a filter on a per-slice basis or on a per-partition basis and performing encoding according to an embodiment of the present invention.

Referring to FIG. 28, if an input image is input to the encoding apparatus (step 901b), the prediction unit for performing inter or intra-frame prediction on the input image is split by using the above-described various partitioning methods, a motion vector is generated on a per-block basis by searching regions similar to the partitioned blocks to be currently encoded in at least one reference picture (which has been encoded and stored in the frame buffer 651) positioned before and/or behind the picture to be currently encoded for each of the partitioned blocks, and motion compensation is performed using the generated motion vector and picture, thereby generating a prediction block (or predicted prediction unit) (step 903b).

Then, the encoding apparatus calculates the sub-pixel value by selecting the interpolating filter used for motion compensation inter-frame prediction on the basis more precise than the picture basis—for example, slice basis, prediction unit basis, or partition basis (the partition basis may include the extended macroblock, macroblock, or block) (step 905b). Specifically, as described above, the encoding apparatus calculates the sub-pixel value by selecting the filter information—filter index or filer coefficient—of the interpolating filter used for motion compensation inter-frame prediction on the basis more precise than the picture basis—for example, slice basis, prediction unit basis, or partition basis and performs encoding.

When the partition basis is used on the basis of the filter information—filter index or filter coefficient—of the interpolating filter, the encoding apparatus uses the whole merged block as the transmission basis of the motion parameter and/or filter information by using the above-described block merging.

Further, the encoding apparatus adaptively selects and uses motion vector precision or pixel precision among ½ pel, ¼ pel, and ⅛ pel with respect to the extended macroblock, so that when the extended macroblock is used, encoding efficiency may be increased. For example, upon application of ½ pel motion vector precision or pixel precision, in case of picture P, the 6-tab interpolating filter having filter coefficients ((1, −5, 20, 20, −5, 1)/32) is used to be able to generate 1/2 pel pixel precision signal. Upon application of ¼ pel motion vector precision or pixel precision, ½ pel pixel precision signal value is generated and applied with an average value filter, thereby generating ¼ pel pixel precision signal. Upon application of ⅛ pel motion vector precision or pixel precision, ¼ pel pixel precision signal value is generated and then applied with the average value filter, thereby generating ⅛ pel pixel precision signal.

The encoding apparatus obtains a difference between the current prediction unit and the predicted prediction unit to thereby generate the residue, and transforms and quantizes I (step 907b), and entropy-encodes header information, such as the quantized DCT coefficients, motion parameter, and filter information (or syntax element), thereby generating a bit stream (step 909b).

Entropy encoding reduces the number of bits necessary for representing the syntax elements. That is, the entropy encoding is a loss-free operation targeted to minimize the number of bits necessary for representing symbols transmitted or stored using distribution characteristics of the syntax elements that some symbols occur more frequently than other symbols.

In the image encoding/decoding method according to the embodiments of the present invention, without filter information for each prediction block being transmitted, block merging is used so that the filter information is once transmitted for the whole merged block to thereby reduce the amount of transmission of the filter information, thus increasing encoding efficiency of high-definition images having a HD, ultra HD or higher resolution.

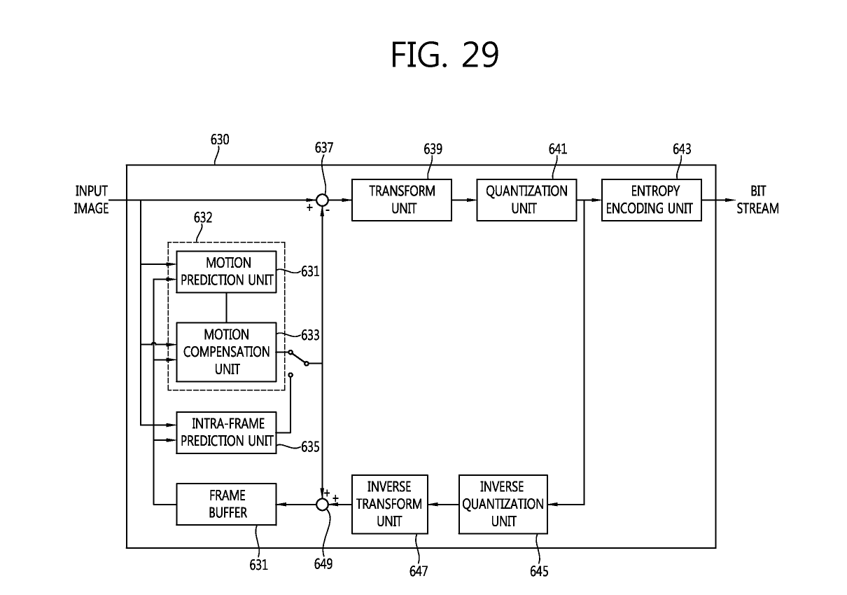

FIG. 29 is a block illustrating an image encoding apparatus using block merging according to an embodiment of the present invention and for describing a configuration of an image encoding apparatus for selecting and encoding a filter on the basis of a slice, prediction unit, or partition according to another embodiment of the present invention.

Referring to FIG. 29, the image encoding apparatus includes an encoding unit 630. The encoding unit 630 may include an inter-frame prediction unit 632, an intra-frame prediction unit 635, a subtracter 637, a transform unit 639, a quantization unit 641, an entropy encoding unit 643, an inverse quantization unit 645, an inverse transform unit 647, an adder 649, and a frame buffer 651. The inter-frame prediction unit 632 includes a motion prediction unit 631 and a motion compensation unit 633.

The encoding unit 630 performs encoding on an input image. The input image may be used for intra-frame prediction in the intra-frame prediction unit 635 or for inter-frame prediction in the inter-frame prediction unit 632 on a per-prediction unit (PU) basis.

The size of the prediction unit applying to inter or intra-frame prediction may be determined according to the temporal frequency characteristics of the stored frame (or picture) after the input image is stored in a buffer (not shown) in the encoding apparatus. For example, the prediction unit determining unit 610 analyzes the temporal frequency characteristics of the n−1th frame (or picture) and the nth frame (or picture), and if the analyzed temporal frequency characteristic value is less than a preset first threshold value, determines the size of the prediction unit as 64×64 pixels, if the analyzed temporal frequency characteristic value is the preset first threshold value and less than a second threshold value, determines the size of the prediction unit as 32×32 pixels, and if the analyzed temporal frequency characteristic value is the preset second threshold value and more, determines the size of the prediction unit as 16×16 pixels or less. Here, the first threshold value may refer to a temporal frequency characteristic value when the first threshold value is smaller in the degree of variation between frames (or pictures) than the second threshold value.

The size of the prediction unit applying to the inter or intra-frame prediction may be determined according to the spatial frequency characteristics of the stored frame (or picture) after the input image is stored in a buffer (not shown) in the encoding apparatus. For example, in the case that the input frame (or picture) has high image homogeneity or high uniformity, the size of the prediction unit may be set high to 32×32 pixels or more, and in the case that the frame (or picture) has low image homogeneity or low uniformity (that is, when spatial frequency is high), the size of the prediction unit may be set low to 16×16 pixels or less.

Although not shown in FIG. 8, the operation of determining the size of the prediction unit may be performed by an encoding controller (not shown) receiving the input image or may be performed by a separate prediction unit determining unit (not shown) receiving the input image. For example, the size of the prediction unit may have a size of 16×16 pixels or less, 32×32 pixels, or 64×64 pixels.

As described above, the prediction unit information including the prediction unit size determined for inter or intra-frame prediction is provided to the entropy encoding unit 643 and provided to the encoding unit 630 on the basis of the prediction unit having the determined size. Specifically, in the case that encoding and decoding are performed using the extended macroblock or extended macroblock size, the prediction block information may include macroblock size information or extended macroblock size information. Here, the extended macroblock size means 32×32 pixels or more, and may include, e.g., 32×32 pixels, 64×64 pixels, or 128×128 pixels. In the case that encoding or decoding is performed using the above-described recursive coding unit (CU), the prediction unit information may include the size information on the leaf coding unit (LCU) used for inter or intra-frame prediction, i.e., size information of the prediction unit instead of the size information of the macroblock, and the prediction unit information may further include the size of the largest coding unit (LCU), the size of the smallest coding unit (SCU), the maximally allowable hierarchical level or hierarchical depth, and flag information.

The encoding unit 630 performs encoding on the prediction unit having the determined size.

The inter-frame prediction unit 632 splits the provided prediction unit to be currently encoded by using the above-described partitioning methods, such as asymmetric partitioning, or geometrical partitioning, and estimates motion on the basis of the partitioned block, thereby generating the motion vector.

The motion prediction unit 631 splits the provided current prediction unit by using the above-described various partitioning methods and searches a region similar to the partitioned block currently encoded in at least one reference picture (which has been encoded and stored in the frame buffer 651) positioned before and/or behind the picture currently encoded for each partitioned block, thereby generating the motion vector on a per-block basis. Here, the size of the block used for motion estimation may vary, and when applied with the asymmetric partitioning or geometrical partitioning according to the embodiments of the present invention, the block may have geometrical shapes, such as ‘ [symbol] ’ or triangle, or asymmetric shapes, such as rectangle, as shown in FIGS. 6 to 11, as well as the existing square.

The motion compensation unit 633 performs motion compensation using the reference picture and the motion vector generated from the motion prediction unit 631 and generates the prediction block (or predicted prediction unit).

The inter-frame prediction unit 632 obtains the motion parameter for each merged block by performing the above-described merging. The per-block motion parameter merged by the above-described block merging is sent to the decoder.

Further, the inter-frame prediction unit 632 selects an interpolating filter used for motion compensation inter-frame prediction on the basis more precise than the picture basis—for example, slice basis or partition basis (the partition basis may include an extended macroblock, macroblock, or block) as described above, thereby calculating the sub-pixel value.

In the case that the partition basis is used on the basis of transmission of the filter information—filter index or filter coefficient—of the interpolating filter, the inter-frame prediction unit 632 uses the whole block merged using the above-described block merging as the basis of transmission of the motion parameter and/or filter information.

Further, the inter-frame prediction unit 632 may adaptively select and use motion vector precision or pixel precision for the extended macroblock among ½ pel, ¼ pel, and ⅛ pel, so that when the extended macroblock is used, encoding efficiency may be increased. For example, upon application of ½ pel motion vector precision or pixel precision, in case of picture P, 6-tab interpolating filter having the filter coefficients ((1, −5, 20, 20, 05, 1)/32) may be used to generate 1/2 pel pixel precision signal. Upon application of ¼ pel motion vector precision or pixel precision, ½ pel pixel precision signal value is generated and then applied with the average filter, thereby ¼ pel precision signal may be generated. Upon application of ⅛ pel motion vector precision or pixel precision, ¼ pel pixel precision signal value is generated and applied with the average filter to generate 1/8 pel pixel precision signal.

The intra-frame prediction unit 635 uses a pixel correlation between blocks to thereby perform inter-frame prediction encoding. The intra-frame prediction unit 635 performs intra-frame prediction that obtains the prediction block of the current prediction unit by predicting a pixel value from previously encoded pixel values of the block interpolating filter the current frame (or picture).

The subtracter 637 substrates the prediction block (or predicted prediction unit) provided from the motion compensation unit 633 and the current block (or current prediction unit) to thereby generate the residue, and the transform unit 639 and the quantization unit 641 perform DCT (Discrete Cosine Transform) and quantization on the residue. Here, the transform unit 639 may perform transform based on the prediction unit size information to the size, for example, 32×32 or 64×64 pixels. Or, the transform unit 639 may perform transform on the basis of a separate transform unit (TU) independently from the prediction unit size information provided from the prediction unit determining unit 610. For example, the size of the transform unit TU may be from the minimum of 4×4 pixels to the maximum of 64×64 pixels. Or, the maximum size of the transform unit TU may be 64×64 pixels or more—for example, 128×128 pixels. The transform unit size information may be included interpolating filter the transform unit information and transmitted to the decoder.

The entropy encoding unit 643 entropy-encodes the header information, such as the quantized DCT coefficients, motion vector, determined prediction unit information, partition information, filter information, or transform unit information, thereby generating a bit stream.

The inverse quantization unit 645 and the inverse transform unit 647 inverse-quantizes and inverse-transforms data quantized by the quantization unit 641. The adder 649 adds the inversed data and the predicted prediction unit provided from the motion compensation unit 633 to thereby restore the image and provides the restored image to the frame buffer 651, and the frame buffer 651 stores the restored image.

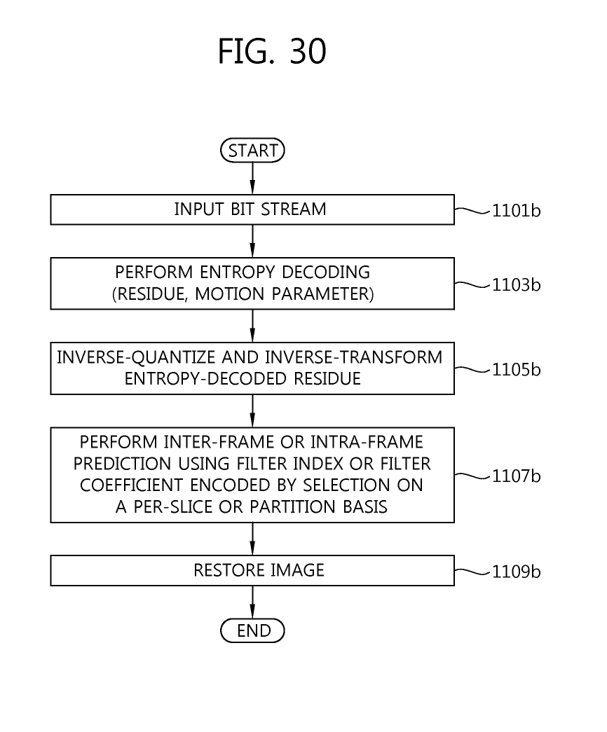

FIG. 30 is a flowchart illustrating an image decoding method according to an embodiment of the present invention.

Referring to FIG. 30, the decoding apparatus receives the bit stream from the encoding apparatus (step 1101b).

Thereafter, the decoding apparatus entropy-decodes the received bit stream (step 1103b). The data decoded through entropy decoding includes the residue representing a difference between the current prediction unit and the predicted prediction unit. The header information decoded through entropy decoding may include the additional information, such as the prediction unit information, motion parameter and/or filter information for motion compensation and prediction—filter index or filter coefficient. The prediction unit information may include prediction unit size information. The motion parameter and/or filter information may include the motion parameter and/or filter information transmitted for each of the blocks merged by the block merging methods according to the embodiments of the present invention.

Here, in the case that encoding and decoding are performed by the above-described recursive coding unit (CU) instead of using the extended macroblock and the extended macroblock size, the prediction unit (PU) information may include the size of the largest coding unit (LCU), the size of the smallest coding unit (SCU), the maximally allowable hierarchical level or hierarchical depth, and flag information.

A decoding controller (not shown) receives information on the prediction unit (PU) size that has applied in the encoding apparatus from the decoding apparatus and may perform the motion compensation decoding or inverse transform or inverse quantization to be described later according to the prediction unit (PU) size that has applied in the encoding apparatus.

The decoding apparatus inverse-quantizes and inverse-transforms the entropy-decoded residue (step 1105b). The inverse transform process may be performed on the basis of the prediction unit size (for example, 32×32 pixels, 64×64 pixels, or 16×16 pixels).

The decoding apparatus performs inter or intra-frame prediction using the prediction unit size information, motion parameter and filter information for motion compensation and prediction, and previously restored picture, thereby generating the predicted prediction unit (step 1107b). The decoding apparatus performs inter or intra-frame prediction using the motion parameter and/or filter information transmitted for each of the blocks merged by the block merging methods according to the embodiments of the present invention.

Further, the decoder performs motion compensation on the extended macroblock through adaptive selection among ½ pel, ¼ pel, and ⅛ pel based on the selected pixel precision information with respect to the extended macroblock encoded by adaptively selecting the motion vector precision or pixel precision among ½ pel, ¼ pel, and ⅛ pel.

The decoder adds the inverse-quantized and inverse-transformed reside and the prediction unit predicted through the inter or intra-frame prediction, thereby restoring the image (step 1109b).

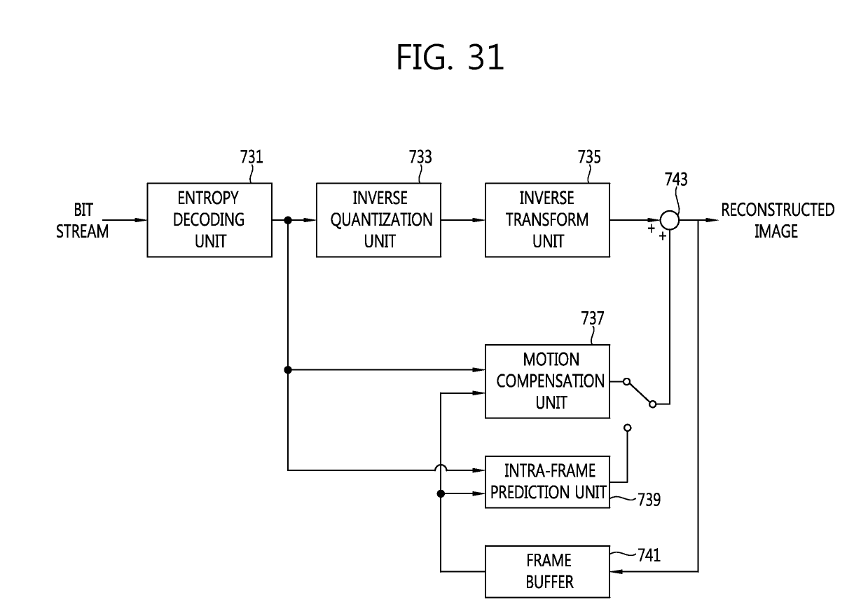

FIG. 31 is a block diagram illustrating a configuration of an image decoding apparatus according to an embodiment of the present invention.

Referring to FIG. 31, the decoding apparatus according to an embodiment of the present invention includes an entropy decoding unit 731, an inverse quantization unit 733, an inverse transform unit 735, a motion compensation unit 737, an intra-frame prediction unit 739, a frame buffer 741, and an adder 743.

The entropy decoding unit 731 receives the compressed bit stream and performs entropy decoding, thereby generating the quantized coefficient. The inverse quantization unit 733 and the inverse transform unit 735 perform inverse quantization and inverse transform on the quantized coefficient to thereby restore the residue.

The header information decoded by the entropy decoding unit 731 may include the prediction unit size information, and the prediction unit size may be an extended macroblock size, such as, e.g., 16×16 pixels, 32×32 pixels, 64×64 pixels, or 128×128 pixels. Further, the decoded header information may include the motion parameter and/or filter information—filter index or filter coefficient—for motion compensation and prediction. The motion parameter may include the motion parameter transmitted for each of the blocks merged by the block merging methods according to the embodiments of the present invention. The filter information may include the filter information transmitted for each of the blocks merged by the block merging methods according to the embodiments of the present invention.

The motion compensation unit 737 performs motion compensation by using the motion parameter and/or filter information on the prediction unit having the same size of the prediction unit encoded by the header information decoded from the bit stream by the entropy decoding unit 731, thereby generating the predicted prediction unit. The motion compensation unit 737 performs motion compensation by using the motion parameter and/or filter information transmitted for each of the blocks merged by the block merging methods according to the embodiments of the present invention, thereby generating the predicted prediction unit.

Further, the motion compensation unit 737 performs motion compensation on the extended macroblock through adaptive selection among ½ pel, ¼ pel, and ⅛ pel based on the selected pixel precision information with respect to the extended macroblock encoded by adaptively selecting the motion vector precision or pixel precision among ½ pel, ¼ pel, and ⅛ pel.

The intra-frame prediction unit 739 performs inter-frame prediction encoding by using a pixel correlation between blocks. The intra-frame prediction unit 739 performs intra-frame prediction that predicts and obtains a pixel value from pixel values previously encoded interpolating filter the current frame (or picture) of the current prediction unit.

The adder 743 adds the residue provided from the inverse transform unit 735 and the predicted prediction unit provided from the motion compensation unit 737 to thereby restore the image and provides the restored image to the frame buffer 741, and the frame buffer 741 stores the restored image. That is, the decoder performs decoding by adding the compressed prediction error (the residue provided from the inverse transform unit 735) to the prediction unit. Although the embodiments of the present invention have been described, it will be understood by those skilled in the art that various modifications to the invention may be made without departing from the spirit and scope of the invention claimed in the claims.

What is claimed is:

1. A method of decoding an image using block merging, the method comprising the steps of:
entropy-decoding a received bit stream and inverse-quantizing and inverse-transforming a residue;
performing motion compensation using prediction unit information and a motion parameter to generate a prediction unit;
adding the residue to the prediction unit to restore the image, wherein after partitioning on the prediction unit is done, among blocks belonging to a mergeable block set, a block merged with a current block has the same motion parameter, wherein a coding unit CU has a recursive tree structure.

2. The method of claim 1, wherein the mergeable block set includes at least one of a block generated by asymmetric partitioning.

3. The method of claim 2, wherein header information decoded through the entropy decoding includes prediction unit information and a motion parameter for motion compensation and prediction.

4. The method of claim 3, wherein the motion parameter includes a motion parameter transmitted for each block merged by the block merging.

5. The method of claim 1, wherein a prediction unit corresponds to a leaf coding unit when the coding unit is split and reaches a maximum permissible depth.

6. The method of claim 1, wherein a size of a minimum coding unit SCU is included in a sequence parameter set (SPS).

7. The method of claim 1, wherein a partition splitting is achieved by an asymmetric partitioning method.

8. The method of claim 7, wherein the asymmetric partitioning is conducted along a horizontal direction to split the prediction unit into a partition P11a having a size of 64×16 and a partition P21a having a size of 64×48 or into a partition P12a having a size of 64×48 and a partition P22a having a size of 64×16.

9. The method of claim 7, wherein the asymmetric partitioning is performed along a vertical direction to split the prediction unit into a partition P13a having a size of 16×64 and a partition P23a having 48×64 or into a partition P14a having a size of 48×64 and a partition P24a having a size of 16×64.
